(19) United States
(12) Patent Application Publication
(10) Pub. No.: US 2026/0290377 A1
(43) Pub. Date: Sep. 24, 2026

(54) SYSTEM

(71) Applicant: SoftBank Group Corp., Tokyo (JP)

(72) Inventor: Genki WATABE, Tokyo (JP)

(73) Assignee: SoftBank Group Corp., Tokyo (JP)

(21) Appl. No.: 19/562,929

(22) Filed: Mar. 11, 2026

(30) Foreign Application Priority Data
Mar. 19, 2025 (JP) 2025-044973

(51) Int. Cl. G10L 25/63; G10L 15/183

(52) U.S. Cl. CPC G10L 25/63; G10L 15/183

(57) ABSTRACT

A system includes a processor that is configured to generate a first prompt that instructs analysis of a user's interests and skills, generate a second prompt that instructs clarification of a user's request, and generate a third prompt that instructs analysis of a user's emotional state and provision of a suggestion based on a result of the analysis.

### CROSS-REFERENCE TO RELATED APPLICATION

This application is based on and claims priority under 35 USC 119 from Japanese Patent Application No. 2025-044973 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional business networking systems and communication support systems mainly rely on explicit user inputs such as manually entered interests, skills, or search queries. Such systems are not well suited to situations where a user's intention or request is vague, low in resolution, or not clearly articulated. In particular, when a user cannot concretely express what kind of partner, information, or support is desired, existing systems have difficulty in providing appropriate guidance or suggestions. Furthermore, conventional systems generally do not generate prompts in a systematic manner for instructing analysis of a user's interests and skills, clarification of a user's request, or analysis of a user's emotional state, and therefore fail to adaptively support the user's decision making and communication behavior. As a result, users may experience low-quality matching, inefficient search processes, and insufficient emotional support during important business or communication interactions. There is a need for a system that automatically generates prompts guiding: (i) analysis of user interests and skills, (ii) clarification of ambiguous user requests, and (iii) analysis of user emotional state and provision of suggestions, and that further utilizes generative artificial intelligence models and behavior/profile analysis to discover latent connection demands and enhance the quality of recommendations.

### SUMMARY

To solve the above-described problems, according to one aspect of the present invention, there is provided a system comprising a processor, wherein the processor is configured to generate a first prompt that instructs analysis of a user's interests and skills, generate a second prompt that instructs clarification of a user's request, and generate a third prompt that instructs analysis of a user's emotional state and provision of a suggestion based on a result of the analysis. In one embodiment, the processor is further configured to analyze the user's interests and skills by using a generative artificial intelligence model in response to the first prompt, thereby enabling extraction, inference, and structuring of user characteristics even when the user's self-description is incomplete or ambiguous. In another embodiment, the processor is configured to analyze a user's behavior history and profile information to discover a latent connection demand, and to use this analysis in conjunction with the prompts to propose suitable partners, information, or actions. Through these means, the system can both clarify low-resolution user requests and dynamically adapt prompts and suggestions to the user's emotional state, thereby improving the relevance, timeliness, and psychological acceptability of recommendations for business networking and communication support.

The term “system” refers to a combination of hardware and software components including at least one processor, memory, and one or more programs executed by the processor to perform the functions described in the claims.

The term “processor” refers to one or more hardware processing units, such as a central processing unit (CPU), a graphics processing unit (GPU), or a dedicated accelerator, that execute instructions stored in a memory to perform computational and control operations of the system.

The term “prompt” refers to data representing a request, instruction, or guidance message that is generated by the processor and is used to instruct another component, such as a software module or an artificial intelligence model, to perform a specified analysis or operation.

The term “first prompt” refers to a prompt generated by the processor that is specifically configured to instruct an analysis of a user's interests and skills.

The term “second prompt” refers to a prompt generated by the processor that is specifically configured to instruct clarification of a user's request, including elicitation of additional information, constraints, or preferences from the user.

The term “third prompt” refers to a prompt generated by the processor that is specifically configured to instruct an analysis of a user's emotional state and to further instruct provision of a suggestion based on a result of that analysis.

The term “user's interests and skills” refers to information indicating areas of interest, fields of activity, technical abilities, professional competencies, or other capabilities of a user, whether explicitly provided by the user or inferred from user data.

The term “user's request” refers to a statement, query, or expression of need or intention provided by the user, which may be vague, low in resolution, or incomplete, and which may require clarification to determine a concrete objective or action.

The term “user's emotional state” refers to an affective condition of the user, such as being positive, neutral, negative, anxious, confident, or uncertain, which is inferred from user data including text, voice, behavior patterns, or other signals.

The term “suggestion” refers to information, advice, recommendation, or proposed action output by the system in response to analyzed user data, including but not limited to proposals of partners, resources, content, or next steps.

The term “generative artificial intelligence model” refers to a machine learning model, such as a large language model or other generative model, that is configured to generate output data, including text or feature representations, in response to input data, and that can be used to analyze and structure user-related information.

The term “user's behavior history” refers to recorded data representing past actions of the user within or in association with the system, including but not limited to event participation, content viewing, searches, communications, and interactions with other users or resources.

The term “profile information” refers to structured or semi-structured data associated with a user account, including but not limited to name, occupation, industry, interests, skills, experience, and other attributes that describe the user.

The term “latent connection demand” refers to a potential need or opportunity for the user to form a connection, relationship, or interaction with other users or entities, which is not explicitly requested by the user but is inferred from the user's behavior history, profile information, or emotional state.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

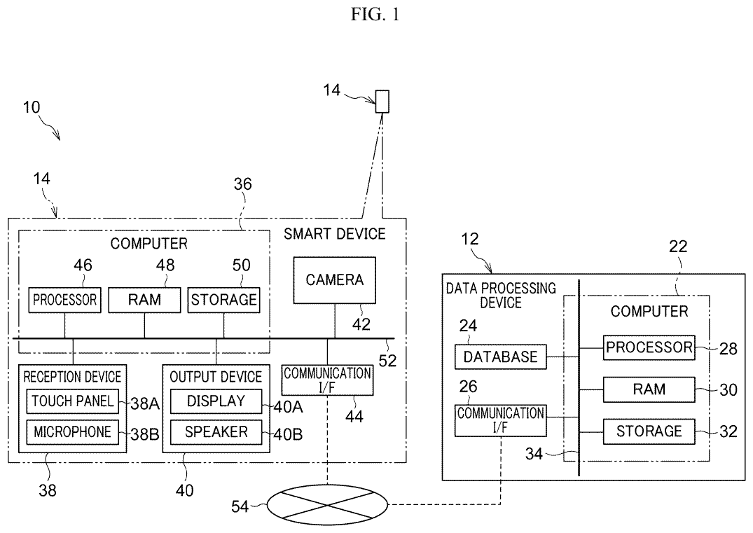

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

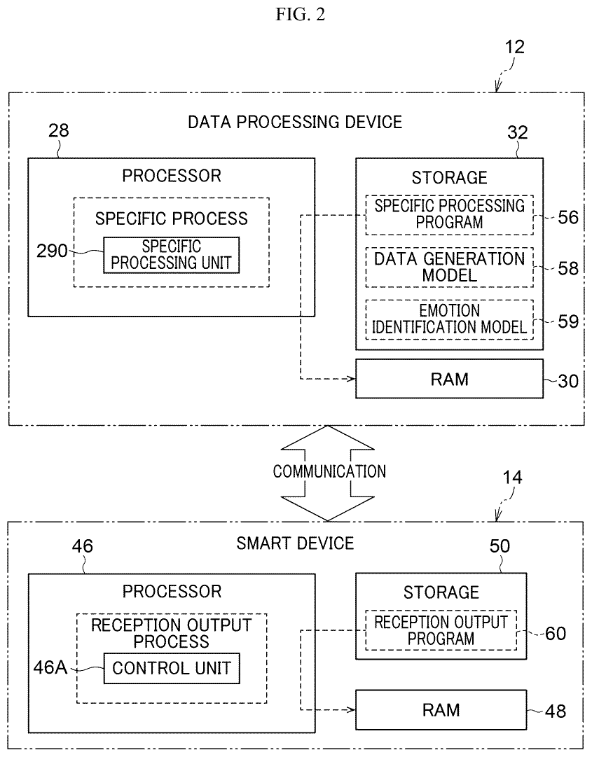

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented matching platforms that connect users based on interests or skills suffer from several technical limitations in how they acquire, represent, and process user data on computing hardware. First, typical systems store user interests and skills as unstructured text and apply static, manually tuned heuristics or simplistic keyword matching. Such approaches cause inefficient use of processor and memory resources because irrelevant or noisy terms are processed without effective normalization, and they generate low-quality similarity scores that do not accurately reflect user affinity. As a result, the system must repeatedly execute matching routines with poor convergence characteristics, increasing computational load on servers and storage subsystems.

Second, conventional systems generally treat similarity computation and notification logic as fixed pipelines, with hard-coded thresholds and pre-defined ranking criteria. When user distributions, content characteristics, or interaction patterns change over time, the system cannot adapt its internal parameters in a data-driven manner. This rigidity forces developers to manually reconfigure algorithms and database queries, which leads to suboptimal performance, unnecessary resource consumption, and delays in deploying improved models. In particular, fixed thresholds may either over-generate candidate pairs, causing unnecessary network traffic and input/output operations for notifications, or under-generate pairs, failing to exploit the capability of the underlying computing platform.

Third, traditional systems often separate user matching from subsequent communication in a loosely coupled manner. Messages and notifications are handled by independent modules or external services without integrated feedback into the matching logic. Consequently, the server cannot systematically exploit behavioral data, such as actual message exchanges and interaction patterns, to refine the similarity computation or connection suggestions. This leads to inefficient utilization of stored interaction data, redundant storage operations, and missed opportunities to optimize database access patterns and network usage.

Fourth, while generative artificial intelligence models can produce detailed analyses and recommendations, existing platforms typically use such models only at the user interface level, for example to generate natural language descriptions, and do not technically integrate model outputs into the core control logic of the matching engine. As a result, the system does not take advantage of the generative model's capability to optimize preprocessing strategies, feature-space representations, or similarity thresholds in a way that improves the performance and adaptability of the underlying computer system. The absence of a structured prompt-and-response loop at the processor level prevents dynamic reconfiguration of algorithm parameters and inhibits continuous tuning of the computational pipeline.

Accordingly, there is a need for a computer-implemented system that: (i) structures user interest and skill information into feature-space vector representations suitable for efficient similarity computation on a server processor; (ii) integrates a generative artificial intelligence model through well-defined prompt sentences so that the server can dynamically adjust preprocessing methods, similarity thresholds, and selection criteria; (iii) unifies matching, notification, and communication handling so that recorded user behavior and profile information in storage devices can be exploited to refine matching and reduce unnecessary computation; and (iv) thereby improves the technical operation of the computer system itself, including processor utilization, memory access patterns, database query efficiency, and network traffic associated with notification and messaging.

The specific processing by the specific processing unit 290 of the data processing device 12 in Example 1 is realized by the following means.

The present invention provides a server comprising a processor configured to receive user interest information and user skill information from a communication terminal, verify and store the user interest information and the user skill information in an information storage device, preprocess text information derived from the stored user interest information and the stored user skill information to generate vector representations in a feature space, compute similarity indices between the vector representations to extract pairs of users, select connection candidate users based on the similarity indices, generate and transmit notification information including connection proposal information to the connection candidate users by using an electronic communication unit or an in-platform notification function, generate interaction or bulletin screens for information exchange and record and relay message information associated with the interaction or bulletin screens, and further generate and transmit a prompt sentence to an external generative information processing model, receive response information from the external generative information processing model, and use the response information as control information to update at least one of the text preprocessing method, vector representation generation conditions, similarity index thresholds, or selection conditions for the connection candidate users. This enables dynamic, data-driven reconfiguration of the matching and communication pipeline at the processor level, improving similarity computation accuracy, reducing unnecessary notification and messaging operations, and enhancing overall efficiency and adaptability of the computer system in managing user connection and interaction processes.

The term “system” refers to an arrangement of one or more hardware devices and software components that cooperatively perform information processing operations as described herein.

The term “processor” refers to a hardware computation unit, such as a central processing unit or a processing core, configured to execute instructions that implement the functions described in the claims.

The term “communication terminal” refers to an endpoint computing device, such as a mobile device, a portable device, or a desktop device, operated by a user to transmit or receive information to or from the system.

The term “user interest information” refers to data that describes subject matters, topics, or fields toward which a user has a preference or curiosity, expressed, for example, as text data.

The term “user skill information” refers to data that describes abilities, competencies, or expertise possessed by a user, expressed, for example, as text data.

The term “information storage device” refers to a logical or physical storage resource, such as a memory device or a storage subsystem, configured to store user information, intermediate processing results, and control information.

The term “text information” refers to character-based data, including natural language strings, obtained from or derived from user interest information, user skill information, or related profile data.

The term “preprocess” refers to performing operations on text information, such as normalization, tokenization, filtering, or transformation, to make the text suitable for further numerical or logical processing.

The term “feature space” refers to a mathematical space in which each dimension corresponds to a feature derived from text information, and in which user profiles are represented as numerical vectors.

The term “vector representation” refers to a numerical array that represents characteristics of text information or a user profile in the feature space.

The term “similarity index” refers to a numerical value that quantifies a degree of resemblance or affinity between two vector representations or between two user profiles.

The term “connection candidate user” refers to a user that is selected as a potential counterpart for interaction with another user based on one or more similarity indices or selection conditions.

The term “notification information” refers to data that indicates a message or alert to be presented to a user, including at least one of connection proposal information, identifiers of counterpart users, or links to interaction screens.

The term “connection proposal information” refers to part of the notification information that recommends initiation of communication or association between two or more users.

The term “electronic communication unit” refers to a functional module, implemented by hardware and software, that transmits or receives information through a communication network, such as an electronic mail subsystem or a messaging subsystem.

The term “in-platform notification function” refers to a function of the system that causes notification information to be displayed within an application interface or a service interface provided by the system itself.

The term “interaction screen” refers to a user interface element that allows a user to input, view, and exchange messages or other interaction data with another user in real time or near real time.

The term “bulletin screen” refers to a user interface element that presents posted information, comments, or threads, enabling asynchronous information exchange among a plurality of users.

The term “message information” refers to content data, such as text, symbols, or structured fields, transmitted or received between users through the interaction screen or the bulletin screen.

The term “counterpart user” refers to another user who is a communication partner or a connection partner of a given user in the system.

The term “prompt sentence” refers to a sequence of characters or tokens that instructs a generative information processing model to perform a specific task, such as analysis, clarification, or proposal generation.

The term “external generative information processing model” refers to a machine-learned model, implemented outside the server, that generates output information, such as text or control parameters, in response to an input prompt sentence.

The term “response information” refers to data generated by the external generative information processing model in reply to a prompt sentence, including but not limited to explanatory text, parameter suggestions, or control directives.

The term “control information” refers to information used by the processor to change, adjust, or update computational procedures, parameters, or selection conditions within the system.

The term “text preprocessing method” refers to a set of rules or operations applied to text information, including segmentation, normalization, feature extraction, or filtering of the text.

The term “vector representation generation conditions” refers to parameters or rules used in producing vector representations, such as weighting schemes, dimensionality, or feature selection criteria.

The term “similarity index threshold” refers to a boundary value used to determine whether a similarity index is sufficient for treating a pair of users as a connection candidate.

The term “selection conditions” refers to rules, criteria, or constraints applied by the processor to determine which users are selected as connection candidate users.

The term “user behavior history information” refers to data indicating user actions within the system, such as access logs, message logs, or interaction counts.

The term “profile information” refers to data associated with a user account, including but not limited to user interest information, user skill information, demographic attributes, or self-descriptive text.

The term “potential connection demand” refers to a likelihood or latent need for establishing a connection between users, inferred from user behavior history information, profile information, or derived patterns.

In one embodiment, a server provides an information exchange platform that connects users based on user interest information and user skill information while internally improving how the server processor performs text preprocessing, vectorization, similarity computation, and parameter control using a generative AI model.

### A. Hardware and Software Configuration

The server includes a processor, a main memory, a non-volatile storage device, a network interface, and an information storage device implemented, for example, as a relational database management system. The server executes an operating system such as a general-purpose server operating system, a web application framework implemented in a general-purpose programming language such as an interpreted language, and a database driver. The server may employ a text processing library, a numerical computation library, and a machine-learning library that provides a term-frequency/inverse-document-frequency transformer and cosine similarity functions.

The terminal includes a processor, a display, an input device, a memory, and a network interface. The terminal executes a web browser that interprets Hypertext Markup Language, Cascading Style Sheets, and a scripting language. The terminal may be a mobile computing device, a tablet computing device, or a stationary computing device.

The user operates the terminal to access the platform over a network, such as a packet-based network or a wireless network. The user inputs text expressing interests and skills using a graphical user interface rendered by the browser.

The information storage device on the server may be implemented using a relational database. The server defines tables such as a user table storing basic user identifiers, a user profile table storing interest text and skill text for each user, a match table storing user pairs and similarity indices, a message table storing interaction messages, and a notification table storing notification records.

### B. Program Generation and Execution Environment

The server generates and executes a program that implements the functions claimed. The server program is structured as multiple modules, including a web interface module, a profile management module, a text preprocessing module, a vectorization module, a similarity computation module, a match selection module, a notification management module, a communication management module, and a generative AI interaction module.

The server stores configuration data, such as similarity thresholds, maximum vector dimensions, stop-word lists, and prompt templates for the generative AI model, in the information storage device or in configuration files in the non-volatile storage.

### C. Handling of User Interest and Skill Information

The server provides a web interface module that outputs HTML pages with input fields labeled as interest fields and skill fields. The terminal renders these pages and sends user-entered text to the server using an HTTP-based protocol.

The server receives user interest information and user skill information as text data from the terminal. The server validates the received text by checking character encodings, enforcing maximum length, filtering disallowed characters, and mapping the text to internal Unicode representations. The server then stores the validated text in the user profile table using parameterized queries, associating each record with a user identifier.

The server may normalize the stored text at this stage by converting to lowercase, removing certain punctuation symbols, and standardizing whitespace. By performing normalization when data is stored rather than repeatedly at query time, the server reduces the number of redundant preprocessing operations in later vectorization steps, thereby improving processor cache utilization and reducing memory bandwidth usage.

### D. Text Preprocessing and Feature Representation

The server performs text preprocessing using the text preprocessing module. The server retrieves interest text and skill text for a plurality of users from the information storage device into main memory. The server concatenates interest text and skill text into a single profile text string per user to create a unified representation.

The server tokenizes each profile text using a deterministic tokenizer that splits strings into tokens based on whitespace and punctuation symbols while applying rules to keep common multi-word expressions together. The server then removes stop words using a stop word list stored in the storage device. The server may apply stemming or lemmatization using a morphological analysis component to reduce different inflected forms to a common root.

The server constructs a vocabulary of tokens from all users'profile texts. The server may limit the vocabulary to the most frequent N tokens, where N is a configuration parameter, to bound the dimensionality of the feature space and reduce the memory required for the feature matrix.

The server uses a machine-learning library to compute term-frequency/inverse-document-frequency (TF-IDF) values for each token in each user's profile. The server constructs a sparse matrix in memory, where each row corresponds to a user and each column corresponds to a token in the vocabulary. Each non-zero cell contains the TF-IDF value. The server uses a compressed sparse row (CSR) or compressed sparse column (CSC) data structure to store this matrix, which reduces memory consumption and accelerates linear algebra operations due to contiguous storage of non-zero entries.

By using sparse matrix representations rather than dense arrays, the server improves computational efficiency of similarity computations on the processor and reduces memory footprint, which in turn lowers cache misses and improves throughput when processing a large number of users.

### E. Similarity Computation and Match Selection

The server uses the similarity computation module to compute similarity indices. The server executes a cosine similarity operation between user vectors. The server may compute all-pairs similarity or, in another embodiment, may apply an approximate nearest neighbor search algorithm, such as locality-sensitive hashing or tree-based indexing, to restrict comparisons to candidate subsets.

The server computes a similarity index for each pair of users based on the cosine of the angle between their TF-IDF vectors. The server obtains a similarity value between zero and one, with larger values indicating higher similarity. The server may ignore diagonal elements where the same user is compared to itself.

The server then uses the match selection module to filter user pairs based on a similarity index threshold stored in the configuration. For each user, the server selects up to a maximum number of connection candidate users by sorting similarity indices and retaining the top values.

The server stores selected user pairs and their similarity indices in the match table. The server records timestamps and status flags indicating whether notifications have been sent. By storing only filtered, high-similarity pairs rather than all pairwise scores, the server reduces the volume of data written to the information storage device and decreases subsequent read operations when generating notifications.

### F. Notification Generation and Communication Handling

The server uses the notification management module to generate notification information. The server queries the match table for candidate pairs that have not yet been notified. For each user, the server constructs notification information that includes identifiers of matched users, similarity indices, and links to interaction screens.

The server transmits notification information through two types of communication channels. First, the server may generate electronic mail messages and send them via an email subsystem using a mail transfer protocol. Second, the server may generate in-platform notifications stored in the notification table. The terminal subsequently queries this table via application programming interfaces and displays notification badges or banners.

The server uses the communication management module to generate interaction screens or bulletin screens. When the user selects a connection proposal, the terminal sends a request to the server, and the server returns an interaction screen implemented as an HTML page with an embedded script that opens a persistent connection or periodically polls the server. When a user sends a message, the terminal transmits message information to the server. The server writes message records into the message table and forwards message information to the counterpart user through the established communication channel.

By unifying the matching subsystem and the communication subsystem in the same server, the system allows the server to correlate similarity indices with actual interaction behavior, enabling later embodiments in which the server refines thresholds based on observed success metrics, such as response rates or conversation duration. This feedback loop reduces the number of low-value connection suggestions and thereby lowers communication load and processing overhead.

### G. Interaction With a Generative AI Model

The server uses the generative AI interaction module to integrate a generative AI model, such as a sequence-to-sequence neural network model that accepts prompt sentences as input and outputs natural language responses and control suggestions. The generative AI model may be an encoder-decoder architecture with multiple layers of self-attention and feedforward sublayers, trained on text data and additional domain-specific data representing user profiles and interactions.

The server generates a prompt sentence that instructs the external generative AI model to perform specified tasks. The server may construct prompt sentences according to templates stored in configuration, inserting current statistics, distributions of similarity indices, or sample profiles. An example of a prompt sentence is:
“Explain in detail an algorithm that performs optimal matching of users based on their interests and skills stored in a relational database, implemented in a programming language using TF-IDF and cosine similarity. Describe how to preprocess the text, compute similarity scores, store matches, and send notifications, and suggest threshold values and feature selection strategies for maximizing matching accuracy while minimizing computation.”

The server transmits the prompt sentence over a secure network connection to an external generative AI model endpoint. The server receives response information that includes explanatory text and explicit parameter suggestions, such as recommended similarity index thresholds, token filtering rules, or maximum vocabulary sizes.

In another example, the server may generate the following prompt sentence for adjusting preprocessing rules:
“Given user profile texts consisting of short phrases describing interests and skills, propose an optimized text preprocessing pipeline and feature selection criteria that reduce vector dimensionality while preserving matching accuracy above 90 percent.”

The server parses the response, extracts numerical values and rule descriptions, and maps them into configuration parameters used by the text preprocessing module and the vectorization module. For example, the server may adjust the minimum term frequency, maximum document frequency, or n-gram range to achieve a better trade-off between precision and computational cost.

### H. Technical Improvement Beyond Human Automation

The server does not merely automate manual matching of user interests. Instead, the server improves core computer operations by dynamically adapting internal processing parameters in response to data patterns and model outputs. Because the generative AI model is used to propose changes in preprocessing, vectorization, and threshold configuration, the server can modify how it constructs sparse matrices, how many dimensions it uses, and which similarity thresholds it applies, without requiring human intervention.

This dynamic reconfiguration causes technical effects. First, the server reduces the number of arithmetic operations in the similarity computation phase by decreasing dimensions or adjusting filters. Second, the server decreases memory usage by discarding infrequent or uninformative tokens, which shortens the feature vectors. Third, the server reduces communication load and notification traffic by tightening thresholds or modifying selection rules for connection candidate users.

The generative AI model itself may be trained using a supervised learning method with a loss function that penalizes mismatches between predicted matching quality and ground-truth connection outcomes, such as user satisfaction scores or continuation of communication. The model parameters are updated using gradient-based optimization, where gradients are computed over attention weights and feedforward layers. The server can periodically retrain or fine-tune the model using logged data stored in the information storage device, resulting in model outputs that are tailored to the platform's data distribution.

The server uses the response information not as vague recommendations but as structured control information. For instance, the server may receive a response indicating “set cosine similarity threshold to 0.83 for profiles with more than 50 tokens” and then encode a rule in its selection logic that applies a higher threshold to verbose profiles. This non-uniform rule cannot be trivially implemented by human operators at scale and leads to non-linear filtering of candidate pairs, thereby reducing CPU usage by avoiding similarity computations in low-value regions of the feature space.

### I. Data Structures, Processing Flow, and Causality of Technical Effects

The server stores user data and intermediate results in specific data structures. The user profile table includes columns for user identifiers, normalized interest text, normalized skill text, and profile update timestamps. The vocabulary is represented as a mapping from tokens to indices stored in memory. The TF-IDF matrix uses a sparse representation with arrays of index pointers, column indices, and values. The match table stores pairs of user identifiers, similarity indices, threshold values used at the time of selection, and notification status flags.

Because the server uses sparse matrices and threshold-based pruning, the server can avoid computing similarity for pairs that are extremely unlikely to match. For example, the server may restrict comparisons to profiles that share at least one token after token hashing, thus reducing the computational complexity from quadratic to near linear in the number of users for many practical distributions.

As the generative AI model proposes changes to hashing functions, token filtering, and similarity thresholds, the server reapplies these changes to the pipeline. When thresholds increase, fewer candidate pairs are recorded in the match table, which reduces I/O operations and storage space. When certain token groups are merged or treated as synonyms, vector representations become denser in meaningful regions of the feature space, which improves cache locality and speed of inner product computations.

The server thus obtains a direct causal relationship between the AI-guided adjustments and measurable system-level improvements such as reduced latency of match computation, lower memory consumption, and higher precision in connection proposals.

### J. Alternative Embodiments and Variations

In another embodiment, the server uses an alternative similarity measure such as Jaccard similarity, Euclidean distance, or a learned similarity metric derived from a neural network that takes two profile vectors as input and outputs a similarity score. The server still controls thresholds and feature selection parameters using the generative AI model via prompt sentences.

In a further embodiment, the server uses a neural network-based embedding model to convert user profile text into dense vectors in a lower-dimensional latent space. The server may employ a transformer encoder trained on profile and interaction data. The server uses a loss function that brings vectors of successfully connected users closer together and pushes unrelated users apart. The server then applies approximate nearest neighbor search in this latent space to find connection candidate users. The server requests from the generative AI model suggestions about dimensionality, training epochs, and margin values in the loss function and uses those suggestions as control information.

In another variation, the server uses the generative AI model not only to adjust parameters, but also to design new rules, such as “for users with low interaction rates, lower the similarity threshold slightly to broaden candidate sets, while for highly active users, raise the threshold to prioritize quality.” The server encodes such rules in a rule table and uses a rule engine to apply them dynamically based on user behavior history information.

In yet another embodiment, the server may be deployed across multiple machines, with one server node responsible for query handling and another for batch similarity computation. The generative AI interaction module may run on a third node. The same principles of prompt-based control and dynamic configuration apply, and the system-level technical effects include improved load distribution and reduced latency for user-facing operations.

### K. Use-Case Example

The user A registers interests such as “data analysis” and skills such as “programming in a high-level language” via a terminal. The server stores this information and computes a TF-IDF vector. The user B registers similar interests and skills. The server computes a similarity index of 0.92 between user A and user B and stores this pair as a connection candidate.

At a later time, the server generates a prompt sentence to the generative AI model requesting optimization of thresholds, receives a response recommending a threshold of 0.85 for profiles with certain token distributions, and updates its configuration. As a result, users with similarity less than 0.85 are no longer suggested as connections, reducing the number of notifications and network messages, while retaining accurate, high-quality matches such as the pair A-B.

Through these concrete structures and processes, the server, terminal, and user cooperate to implement a system in which generative AI model outputs are used to improve core computer operations—vectorization, similarity computation, data storage, and communication handling—rather than merely automating a human matching decision, thereby satisfying the requirements for a technical improvement in computer functionality.

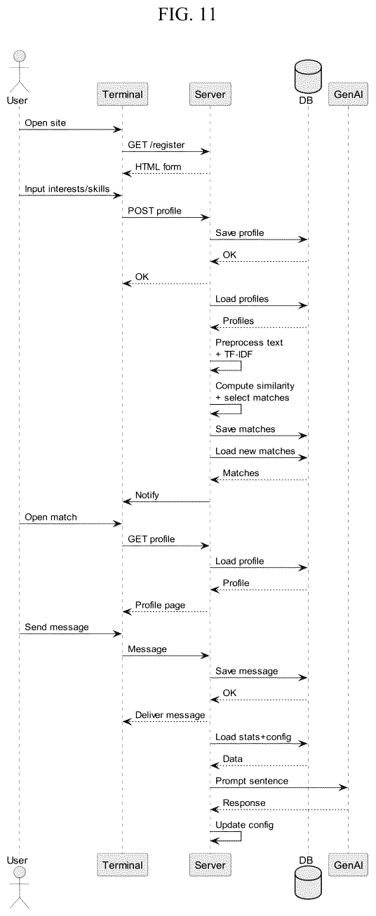

The following describes the processing flow using FIG. 11.

### Step 1:

User operates the terminal to launch a web browser and access a URL of the platform.

Terminal sends an HTTP GET request to the server to obtain an input screen for interest and skill registration.

Server receives the request and outputs an HTML document, style data, and script data as a response.

Input: HTTP GET request including a resource identifier for the registration page.

Output: HTML, CSS, and JavaScript content that defines input fields for user interest information and user skill information.

Server generates this output by reading template files from storage, inserting session identifiers, and composing a complete web page that the terminal can render.

### Step 2:

Terminal renders the received HTML and displays text input fields, labels, and buttons to the user.

User types interest information and skill information as natural language text into the input fields and activates a submit control.

Terminal executes a script that reads values from the input elements and formats them into an HTTP POST request body.

Input: HTML form definition and user keystrokes.

Output: Structured request data containing user identifiers, interest text, and skill text.

Terminal performs data packaging by encoding the text into a chosen format, adding field names, and attaching the data to the POST request addressed to an application endpoint on the server.

### Step 3:

Server receives the HTTP POST request from the terminal and invokes a profile management routine.

Server parses the request body, decodes the character data, and extracts fields corresponding to user identifiers, interest text, and skill text.

Server validates the text by checking length limits, allowed character sets, and required fields.

Input: HTTP POST payload containing raw interest text and skill text.

Output: Normalized, validated text strings along with associated user identifiers.

Server performs data processing by converting encodings to an internal character representation, trimming whitespace, rejecting invalid input, and generating cleaned text ready for storage.

### Step 4:

Server stores the validated profile data in an information storage device implemented as a relational database.

Server constructs parameterized insert or update commands that target a user profile table containing columns for user identifiers, interest text, skill text, and timestamps.

Server transmits the commands to the database engine and commits the transaction.

Input: Normalized interest text, normalized skill text, and user identifiers.

Output: Persistent records in the user profile table representing updated user profile information.

Server performs data operations by binding text and identifiers to statement parameters, executing the statements, and recording a successful commit state or an error status.

### Step 5:

Server periodically invokes a batch-processing routine to prepare text data for similarity computation.

Server queries the information storage device to obtain interest text and skill text for a set of users.

Server concatenates interest text and skill text into a single profile string per user, then tokenizes each string, removes stop words, and optionally applies stemming or lemmatization.

Input: Multiple rows of interest text and skill text retrieved from the user profile table.

Output: Token lists or normalized text sequences for each user profile.

Server performs data transformation by applying string operations and linguistic rules to convert unstructured text into structured token sequences that can be further processed numerically.

### Step 6:

Server generates feature-space representations of the preprocessed user profiles.

Server builds a vocabulary of tokens across all users and assigns each token a unique index.

Server computes term-frequency/inverse-document-frequency (TF-IDF) values for each token in each profile and constructs a sparse matrix where rows represent users and columns represent token indices.

Input: Token lists per user and existing or newly created vocabulary information.

Output: Sparse numerical matrix representing user profiles as vectors in a feature space.

Server performs numerical computation by counting token occurrences, calculating inverse-document-frequency values, multiplying term frequencies by these values, and encoding results into a compressed sparse-row or compressed sparse-column format.

### Step 7:

Server computes similarity indices between user profiles using the generated vectors.

Server calls a similarity computation function that calculates cosine similarity or a similar metric between pairs of user vectors.

Server may restrict comparisons to users that share at least one token or meet other pre-filter conditions.

Input: Sparse TF-IDF matrix or other vector representations of user profiles.

Output: A set of similarity indices associated with pairs of users.

Server performs data operations by computing dot products between vectors, dividing by their magnitudes, and generating numerical similarity scores that quantify affinity between users.

### Step 8:

Server selects connection candidate users based on the similarity indices.

Server filters user pairs by discarding pairs whose similarity index is below a configured threshold and sorts remaining pairs by decreasing similarity.

Server, for each user, selects at most a configured maximum number of top-scoring counterpart users as connection candidates and updates or inserts corresponding records in a match table.

Input: List or matrix of similarity indices and associated user identifier pairs.

Output: Filtered and ranked set of user pairs stored as match records with similarity indices and status flags.

Server performs ranking and filtering operations by comparing similarity values against thresholds, ordering them, and writing only selected matches to persistent storage.

### Step 9:

Server identifies match records requiring user notification.

Server queries the match table to retrieve pairs that meet conditions such as “notification not yet sent” and “similarity index above notification threshold.”

Server generates notification information that includes user identifiers of matched users, similarity scores, and links to interaction screens.

Input: Match records with similarity indices and notification status.

Output: Notification objects containing connection proposal information for each relevant user.

Server performs logical evaluation by inspecting status fields, composing message content, and creating data structures that represent notifications to be delivered.

### Step 10:

Server transmits notifications to users through electronic messaging channels and in-platform mechanisms.

Server passes notification information to an email subsystem or messaging subsystem, which constructs email messages or push notifications containing connection proposals.

Server also inserts notification records in a notification table that the terminal can access via an application programming interface.

Input: Notification objects describing matched counterparts, message content, and delivery preferences.

Output: Delivered emails, platform notifications, and persistent notification records with updated delivery status.

Server performs communication control by formatting messages, establishing connections to messaging servers, sending data over network protocols, and recording the success or failure of delivery attempts.

### Step 11:

Terminal periodically requests notification data from the server when the user accesses the platform.

Server responds with structured notification information, and terminal renders graphical elements such as banners, icons, or lists that show new connection proposals.

User selects a notification to view details of a connection candidate.

Input: Notification records retrieved from the notification table and user selection actions.

Output: Displayed notification elements and selected match identifiers.

Terminal performs data handling by parsing the server response, updating the display, and sending follow-up requests when the user interacts with the notifications.

### Step 12:

Server, upon receiving a request to view a connection candidate, retrieves the candidate's profile information from the user profile table.

Server constructs a profile view including interests, skills, and other permitted fields and sends an HTML-based response to the terminal.

Terminal displays the connection candidate's profile, and user reviews the displayed information.

Input: Request containing identifiers of a match and a counterpart user.

Output: Profile page content describing the counterpart user's interests and skills.

Server performs data retrieval and formatting by querying the database, mapping result fields into template variables, and returning a rendered or partially rendered page.

### Step 13:

User decides to initiate communication and uses the interaction screen to compose a message.

Terminal captures the message text and associated metadata, such as sender and receiver identifiers, then sends this to the server through a communication endpoint.

Server receives the message information, validates the content, and writes a record into the message table.

Input: Message text and communication metadata from the terminal.

Output: Persistent message record stored in the message table and a confirmation status.

Server performs validation and storage operations by checking message length, sanitizing potentially unsafe content, and inserting the message into persistent storage along with a timestamp.

### Step 14:

Server forwards the message to the counterpart user if the counterpart user is currently connected.

Server sends a real-time notification or updates an in-platform message queue.

Terminal of the counterpart user receives the new message notification, retrieves the new message content, and displays it in the interaction screen.

Input: Newly stored message record, user presence information, and counterpart identifiers.

Output: Delivered message content and updated conversation display on the counterpart terminal.

Server performs routing by determining the counterpart's session state, selecting an appropriate communication channel, and transmitting the message data over that channel.

### Step 15:

Server collects and logs user behavior history information related to notifications and communications.

Server records, in the information storage device, whether users open notifications, initiate chats, or ignore suggestions and accumulates counts of successful interactions and durations of conversations.

Input: Events such as message sends, message reads, notification openings, and connection acceptances.

Output: Behavior history records associated with user identifiers and match identifiers.

Server performs logging by creating event entries, attaching timestamps, and aggregating statistics that can later be used to evaluate and refine matching and notification strategies.

### Step 16:

Server generates a prompt sentence for a generative AI model to obtain guidance on improving the matching pipeline.

Server composes the prompt by embedding current configuration values, such as similarity thresholds and vocabulary sizes, and performance statistics, such as acceptance rates or average conversation length.

An example of such a prompt sentence is:
“Explain in detail an algorithm that performs optimal matching of users based on their interests and skills stored in a relational database, implemented in a programming language using TF-IDF and cosine similarity. Describe how to preprocess the text, compute similarity scores, store matches, and send notifications, and suggest threshold values and feature selection strategies for maximizing matching accuracy while minimizing computation.”

Input: Current system parameters and performance metrics stored in the information storage device.

Output: A textual prompt sentence ready to be transmitted to a generative AI model.

Server performs data synthesis by reading configuration and metrics, inserting numerical values and descriptive text into a prompt template, and generating a coherent natural-language instruction.

### Step 17:

Server transmits the prompt sentence to an external generative AI model over a network connection.

Server receives response information from the generative AI model that includes textual explanations, suggested parameter values, and processing rules.

Server parses the received text to extract structured control information, such as recommended similarity thresholds, vocabulary limits, or stop-word lists.

Input: Prompt sentence specifying tasks for algorithm improvement and the corresponding AI-generated response text.

Output: Extracted control information encoded as configuration parameters or rule definitions.

Server performs data analysis by scanning the response for numeric values and keywords, mapping these into internal configuration keys, and validating that extracted values fall within acceptable ranges.

### Step 18:

Server updates internal configuration and processing modules based on the extracted control information.

Server modifies parameters used by the text preprocessing module, such as minimum and maximum token frequency, and parameters used by the vectorization module, such as maximum feature dimension.

Server adjusts thresholds and selection conditions in the match selection module, for example by increasing similarity index thresholds for certain user groups and decreasing them for others, according to rules derived from the response.

Input: Control information derived from the generative AI model response and existing configuration values.

Output: Updated configuration state that affects future executions of preprocessing, vectorization, similarity computation, and match selection.

Server performs configuration management by writing new parameter values into configuration storage, invalidating outdated caches, and reinitializing components that depend on changed settings.

### Step 19:

Server applies the updated configuration during subsequent batch processing and matching runs.

Server executes text preprocessing and vectorization with revised token filters and feature-space dimensionality, computes similarity indices using new thresholds, and records fewer or more matches depending on the updated rules.

Server thereby changes the number and quality of candidate pairs, the size of the sparse matrices, and the number of notifications generated.

Input: User profile data from the information storage device and revised configuration parameters.

Output: New sets of match records and notification records that reflect the adapted algorithm behavior.

Server performs computation with altered data-flow and parameter settings, which results in changed resource usage profiles, such as lower memory consumption, reduced CPU time in similarity calculations, and decreased network traffic for notifications, thus achieving technical improvements in system performance.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented matching platforms that connect users based on profiles or interests typically rely on static attribute comparison and simple keyword matching. Such platforms have several technical limitations from the perspective of computer technology. First, when user requests are ambiguous or low in resolution, the underlying matching algorithms operate on incomplete or noisy input data. As a result, the similarity computation logic and ranking procedures executed by processors and storage subsystems produce suboptimal candidate sets, leading to inefficient utilization of computational resources and repeated, ineffective matching cycles.

Second, conventional systems generally treat user interaction data, such as dialogue content in sessions and user responses to system guidance, as transient data that is not systematically fed back into the matching pipeline. Consequently, the data structures in memory and in persistent storage are not progressively refined to improve similarity models or latent demand detection models over time. This causes redundant computations, increases network and storage load, and fails to adapt the system's internal state to actual user behavior in a technically meaningful manner.

Third, known platforms do not integrate a generative artificial intelligence model in a way that is tightly coupled with the system's context management and matching logic. In many cases, a generative model is only used at the user interface layer as a simple conversational tool. The generative model is not given structured context including user interests, capabilities, and dialogue history, and its outputs are not generated specifically as machine-usable prompt sentences that enhance the quality of the input data for downstream algorithms. This results in a disconnect between the natural language processing layer and the core similarity computation and pattern extraction processes.

Fourth, existing systems lack a mechanism for systematically detecting and exploiting latent patterns of relationship demands from accumulated user behavior information, interest information, and capability information. Without such a mechanism, the system cannot adapt internal models or data indices to proactively suggest collaborator candidates or information resources that match emerging, but not explicitly expressed, needs. This leads to underutilization of stored data, increased search overhead, and degraded efficiency of the matching pipeline at scale.

Therefore, there is a need for an improved computer-implemented system and server architecture that (i) dynamically acquires and structures user-related data from terminals, (ii) executes similarity computations and candidate extraction using refined contextual information, (iii) uses a generative artificial intelligence model to produce targeted prompt sentences based on rich context so as to convert low-resolution user requests into high-quality machine-usable input, and (iv) feeds back dialogue content and user responses into similarity computation and latent pattern extraction. Such a system improves the functioning of the underlying computer components, including processors, memory, storage devices, and communication interfaces, by reducing ineffective matching cycles, optimizing data flows, and enhancing the technical efficiency and accuracy of automated user matching and collaboration support.

The specific processing by the specific processing unit 290 of the data processing device 12 in Application Example 1 is realized by the following means.

The present invention provides a server comprising a processor and one or more storage devices, the processor being configured to acquire, via a communication interface, user interest information and user capability information transmitted from a user terminal, to store the user interest information and the user capability information in the storage devices in association with corresponding user identifiers, to calculate, by executing similarity computation logic on the processor, similarity between users based on the user interest information and the user capability information stored in the storage devices, to extract collaborator candidate users based on results of the similarity calculation, to transmit information on the collaborator candidate users to the user terminal, to cause a display device of the user terminal to present a list of the collaborator candidate users, to generate a communication session based on a collaborator candidate user selected by the user terminal, and to construct a real-time information exchange environment via the communication session, the processor being further configured to generate context information including ambiguous request information acquired from the user terminal, the user interest information, and the user capability information, to input the context information to a generation component that executes a generative artificial intelligence model, to generate, by the generative artificial intelligence model, a prompt sentence that encourages clarification of the ambiguous request information, to transmit the generated prompt sentence to the user terminal so as to prompt a user to clarify contents of the request, and to analyze user behavior information, the user interest information, and the user capability information accumulated in the storage devices to extract latent patterns relating to relationship demands, and to present new collaborator candidate users or information resources based on the latent patterns. This enables the server to technically improve the operation of the matching and collaboration platform by iteratively refining user input quality through context-aware generative prompt sentences, by reusing dialogue content and user responses to update similarity computations and latent pattern models, and by reducing unnecessary computation and communication overhead while enhancing the accuracy and efficiency of automated user matching and real-time collaboration support.

The term “system” refers to a combination of one or more hardware devices and software components that cooperate to execute the processing described in the claims, including at least a server device and one or more user terminals interconnected via a communication network.

The term “processor” refers to one or more hardware processing units, such as a central processing unit or a microprocessor, configured to execute programmed instructions to perform the functions described in the claims.

The term “storage device” refers to one or more hardware storage units, such as a memory device or a non-transitory computer-readable storage medium, configured to store data, programs, and model parameters used by the processor.

The term “communication device” refers to one or more hardware and software components that provide data communication functions between the system and external devices, including network interfaces, communication controllers, and communication protocols.

The term “user terminal” refers to an information processing device operated by a user, such as a mobile terminal, a wearable terminal, or a general-purpose computing device, configured to transmit and receive data to and from the server and to present information to the user.

The term “display device” refers to a hardware component of the user terminal or another device, such as a screen, a head-mounted display, or an augmented reality display, configured to visually present information including lists, messages, and prompt sentences to the user.

The term “user” refers to a human operator who interacts with the system via the user terminal and provides inputs such as interests, capabilities, and requests.

The term “user interest information” refers to data representing topics, fields, or themes in which a user has interest, expressed as one or more items such as keywords, categories, or descriptive text managed by the system.

The term “user capability information” refers to data representing skills, knowledge, experience, or competencies possessed by a user, expressed as one or more items such as skill names, proficiency levels, or descriptive text managed by the system.

The term “user behavior information” refers to data derived from actions taken by the user within the system, including access history, selection history, communication history, and response history.

The term “dialogue history information” refers to data representing past exchanges of messages or communication content between users and/or between a user and the system, stored in association with a session or user identifier.

The term “ambiguous request information” refers to data representing a user's request or requirement whose content, scope, or objective is not clearly specified or is insufficient for precise processing by the system.

The term “context information” refers to a set of data elements that provide situational information for processing by the system, including at least user interest information, user capability information, ambiguous request information, and optionally dialogue history information or session-related information.

The term “similarity” refers to a quantitative value or metric computed by the processor that indicates a degree of relatedness or closeness between two or more users based on their user interest information, user capability information, or other attributes.

The term “similarity computation logic” refers to a set of algorithms or procedures executed by the processor to calculate similarity values, which may include vectorization, distance or similarity metrics, and ranking operations.

The term “collaborator candidate user” refers to a user selected by the system as a potential partner for communication or collaboration with another user, based on similarity or other criteria.

The term “communication session” refers to a logical association managed by the system that enables real-time or near-real-time data exchange between two or more user terminals, identified by a session identifier.

The term “real-time information exchange environment” refers to a communication context provided by the system in which messages or data transmitted by one user terminal are delivered to another user terminal with low latency such that an interactive conversation or collaboration is enabled.

The term “generative model” refers to a model implemented in software and/or hardware that generates textual or other output data from input data, based on learned parameters, and that can be executed on a generation component or processing resource.

The term “generative artificial intelligence model” refers to a generative model that has been trained using machine learning or deep learning techniques on a large dataset to generate natural language or other content, such as a large language model.

The term “generation device” refers to a processing component, which may be included in or coupled to the server, configured to execute the generative model or the generative artificial intelligence model based on context information.

The term “prompt sentence” refers to a text string generated by the generative model or the generative artificial intelligence model, designed to be presented to the user to encourage the user to provide additional or clarified information.

The term “relationship demands” refers to needs or requirements for connections, interactions, or collaborations between users, including explicit demands expressed by the user and latent demands inferred by the system.

The term “latent patterns” refers to relationships, trends, or structures that are not directly observable in individual data items but are inferred by analyzing aggregated user behavior information, user interest information, and user capability information.

The term “information resources” refers to data objects or content, such as documents, links, tutorials, or digital assets, that can be presented by the system to assist the user in achieving a goal or satisfying a relationship demand.

The term “presentation” refers to the act of outputting or displaying information by the system to the user via the user terminal, including visual display, audio output, or other sensory modalities.

The term “extract” refers to the operation of selecting, identifying, or deriving specific data, such as collaborator candidate users or latent patterns, from stored data by executing programmed logic on the processor.

In one embodiment, a server implements the claimed system as a network-based information processing platform. The server comprises at least one processor, a main memory, a non-transitory storage device, and a network interface. The server operates under the control of system software such as a general-purpose operating system and executes application software implemented, for example, using a programming language such as Python on a web application framework such as a generic web framework. The server accesses a relational database management system, such as a generic SQL database, to store and retrieve user-related data. The server further accesses a generative AI model, such as a large language model executing on a graphics processing unit or specialized accelerator, either locally or via a dedicated model-serving component coupled through a network.

A terminal is, for example, a smartphone, a tablet computer, a wearable computing device such as smart glasses, or a personal computer. The terminal comprises a processor, a memory, a display device such as a liquid crystal display or organic light-emitting diode display, an input interface such as a touch panel or keyboard, and a communication interface such as a wireless network interface. The terminal executes a client application or a web browser that communicates with the server over a communication network using protocols such as HTTP and WebSocket. The user operates the terminal to input information and to view information presented by the server.

The server manages user interest information and user capability information as structured data. The server stores, for example, a user table, an interest table, and a capability table in the relational database. The server represents user interest information as normalized strings mapped to category identifiers and may further store vector representations of these interests as numerical feature vectors in separate data fields. The server represents user capability information as skill identifiers, proficiency levels, and optionally experience metrics, again normalized and stored in a structured format. By maintaining these specialized data structures and indices, the server reduces the computational overhead required to perform repeated similarity calculations and facilitates efficient retrieval of user data.

The server computes similarity between users by executing a similarity computation algorithm implemented using numerical computation libraries such as generic linear algebra libraries. In one embodiment, the server represents each user's interests and capabilities as a high-dimensional sparse or dense vector. The server generates such vectors by applying term frequency-inverse document frequency (TF-IDF) transformation or an embedding model, such as a neural network-based sentence encoder, to the textual representations of interests and capabilities. The server stores these vectors in memory for active users and optionally in a dedicated vector storage area on the storage device. The server computes similarity values by applying a mathematical function such as cosine similarity or a learned distance metric between vectors. By precomputing and caching vector representations and using vectorized operations on a processor optimized for such operations, the server improves the speed and scalability of the matching process compared to naïve string comparison or rule-based matching.

In one embodiment, the server uses a generative AI model to generate a prompt sentence that improves the quality of user-provided data. The generative AI model is, for example, a multi-layer neural network such as a transformer-based large language model. The model comprises an embedding layer, multiple self-attention layers, feedforward layers, and a final output layer. The model is trained in advance on large-scale text data using a learning process that optimizes parameters by minimizing a loss function such as cross-entropy between predicted tokens and actual tokens. During training, the model updates its weights using gradient-based optimization such as stochastic gradient descent or its variants. The training process may include data augmentation techniques such as random masking, shuffling, or paraphrasing to improve generalization.

The server provides context information as input to the generative AI model. The server constructs the context information by concatenating or otherwise encoding user interest information, user capability information, and at least one portion of dialogue history or ambiguous request information. The server encodes these elements into token sequences using a tokenizer corresponding to the generative AI model and arranges them in a predefined format that distinguishes, for example, system instructions, user information, and prior dialogue. The server specifies model parameters such as temperature, maximum output length, and top-k or top-p sampling thresholds to control the variability and determinism of the output. By structuring the context information in this way, the server causes the generative AI model to generate output that is specifically adapted to the technical needs of the system, rather than generic conversational output.

The server generates a prompt sentence designed to elicit more specific and machine-usable information from the user. For example, the server may receive from the user an ambiguous request such as “I want to do some machine learning projects, but I'm not sure what exactly.” Based on this input together with stored user interest information such as “data analysis” and “machine learning” and user capability information such as “Python,” the generative AI model generates a prompt sentence such as:
“Please describe what type of data (for example, text, images, or numerical data) you want to work with, and what kind of result (for example, prediction, classification, or recommendation) you expect from the machine learning model.”

In another example, the server provides a context in which the user has interests in “data analysis” and “visualization” and capabilities in “Python” and “dashboard tools.” The generative AI model then generates a prompt sentence such as:
“Explain what kind of dataset you want to visualize, what key indicators you want to track, and what decisions you want to support with the visualization.”

In yet another example, the server detects that the user has not specified collaboration preferences, and the generative AI model generates a prompt sentence such as:
“Describe what role you expect your collaborator to play, such as data engineer, domain expert, or model tuner, and how often you would like to communicate about the project.”

These prompt sentences are not merely user-interface text; they are generated according to internal criteria that maximize downstream algorithmic utility. The server parses the user's responses to such prompt sentences and maps specific terms to structured fields and feature vectors, thereby improving the signal-to-noise ratio of the data consumed by the similarity computation and latent pattern extraction algorithms.

The server analyzes user behavior information, including which collaborator candidate users the user views, which candidates the user selects for communication sessions, and how the user responds to prompt sentences. The server logs dialogue content for sessions, including sequences of messages, timestamps, and identified topics. The server stores this information in dedicated tables such as a session table and a message table, each linked via foreign keys to the user table. By doing so, the server maintains a normalized data schema that supports efficient queries and avoids redundancy.

The server extracts latent patterns relating to relationship demands by applying algorithmic analysis to the accumulated data. In one embodiment, the server applies unsupervised learning techniques, such as clustering algorithms or topic models, to group users and sessions based on interest and capability vectors, interaction frequency, and successful collaboration outcomes. For example, the server may use a clustering algorithm to group users who frequently collaborate on similar types of projects or who tend to respond similarly to prompt sentences. The server may also use matrix factorization or embedding techniques to derive low-dimensional latent vectors that capture hidden affinities between interests, capabilities, and behavioral outcomes. By storing these latent vectors and cluster assignments, the server can rapidly propose new collaborator candidate users or information resources that match inferred, latent demands without executing full recomputations for each query.

The server implements these algorithms as specific computational pipelines, each comprising distinct modules that transform data from one representation to another. For example, a first module retrieves raw user records from the database, a second module transforms textual fields into numerical vectors, a third module applies similarity functions or clustering, and a fourth module formats results for transmission. The modular pipeline design allows the server to reuse intermediate representations, reducing redundant processing and memory usage. For example, because interest and capability vectors are stable over medium time scales, the server can cache them and re-use them for many similarity computations, which improves processing speed and reduces processing load on the processor and memory subsystem.

The server controls the communication sessions used for real-time information exchange between terminals. The server maintains session identifiers and associated metadata in a session management component. The server uses network protocols such as WebSocket to maintain persistent connections between the server and multiple terminals. By managing the flow of messages, including chat messages and prompt sentences, through controlled session channels, the server can prioritize or throttle certain types of data, thereby reducing communication congestion and improving responsiveness. For example, the server may batch low-priority updates while delivering prompt sentences and user responses with higher priority to reduce perceived latency. This technical behavior reduces the number of network round trips compared to more naïve polling implementations and thus reduces overall communication load.

The terminal presents the information received from the server to the user in a human-readable format and transmits user input back to the server. The terminal does not implement the core similarity or generative AI processing; instead, the terminal performs preprocessing and postprocessing specific to its user interface and hardware capabilities. For example, the terminal may locally validate input length or format before transmitting interest and capability information to the server. The terminal may also locally cache previously received lists of collaborator candidate users to reduce the load on the server and network.

The user interacts with the system by entering interests, capabilities, and responses to prompt sentences via the terminal. The user views lists of collaborator candidate users, selects collaborators, and engages in real-time communication sessions. The user's actions generate behavior data that the server uses to update similarity models and pattern extraction processes. The user is not required to be aware of the internal algorithms or data structures, and the system automatically improves its matching quality as more data is accumulated.

From a technical perspective, the described configuration of server, terminal, and generative AI model improves computer technology in several ways. First, by using a generative AI model to generate context-aware prompt sentences that are directly coupled to the system's data structures and algorithms, the server systematically converts ambiguous, low-resolution user input into structured, high-resolution data that can be processed more efficiently. This reduces the number of failed or ineffective matching attempts and therefore reduces processor cycles and memory accesses spent on processing insufficient data.

Second, by integrating similarity computation, generative prompt generation, and latent pattern extraction into a unified architecture, the server implements a feedback loop in which the quality of matches and recommendations improves over time. The reuse of dialogue content and user responses to prompt sentences as input features for similarity and pattern models leads to more accurate predictions of beneficial collaborations, which in turn reduces the number of candidates that must be evaluated. This reduction directly affects computational complexity and improves processing throughput.

Third, the use of specific vectorization techniques, model architectures, and learning procedures yields concrete technical improvements. For instance, by employing embedding-based representations for interests and capabilities, the server can identify relationships that simple keyword matching would miss, enabling more accurate similarity estimation with fewer features. By choosing specific loss functions and optimization algorithms during model training, and by performing data augmentation, the generative AI model produces prompt sentences that are robust to diverse input patterns, thus reducing the need for rule-based postprocessing and manual tuning.

Fourth, the server uses non-conventional rules and procedures that differ from human manual operations. Human operators might attempt to clarify requests by asking generic follow-up questions without considering how subsequent data will be consumed by downstream algorithms. In contrast, the server generates prompt sentences based on an internal objective to maximize reliance on structured fields and to minimize ambiguity in vector representations. This internal objective is realized by designing model prompts and training data such that questions systematically target dimensions that correspond to specific database fields and feature indices. This mapping between natural language text and machine-internal feature spaces is not a mere automation of human questioning, but an engineered coupling that optimizes machine-specific processing.

Fifth, the server reduces communication overhead by combining generative prompt sentences with adaptive matching. When the server detects, by analyzing previous user responses, that a particular category of prompt sentence is consistently effective for a given user profile, the server can reuse or adapt that category of prompt sentence rather than conducting broad searches or transferring excessive candidate data. As a result, the server transmits fewer, more targeted data packets across the network, improving bandwidth efficiency.

Various alternative embodiments are possible within this framework. In one variation, the server uses a different type of generative AI model, such as a recurrent neural network or a convolutional sequence model, with analogous input and output structures. In another variation, the server uses different similarity metrics, such as learned Mahalanobis distance or kernel-based measures, while keeping the same vectorization pipeline. In yet another variation, the server employs a distributed architecture in which the generative AI model runs on a separate processing node, and the main server node communicates with that model-serving node via an internal network. In another embodiment, the terminal includes additional sensors, such as a camera or microphone, and the server enriches user behavior information with multimodal data; the server then extends its feature vectors to include features derived from audio or visual content, enabling more nuanced pattern extraction.

In all these embodiments, the central technical concept remains that the server structures and processes user data, similarity computations, generative AI prompt sentences, and latent pattern extraction in a coordinated manner that enhances the functioning of the computer system itself. The described architecture, data structures, and algorithms enable improved computational efficiency, higher matching accuracy, reduced network load, and more effective utilization of storage and processing resources compared to conventional systems that do not employ such integrated and context-aware generative AI and feedback mechanisms.

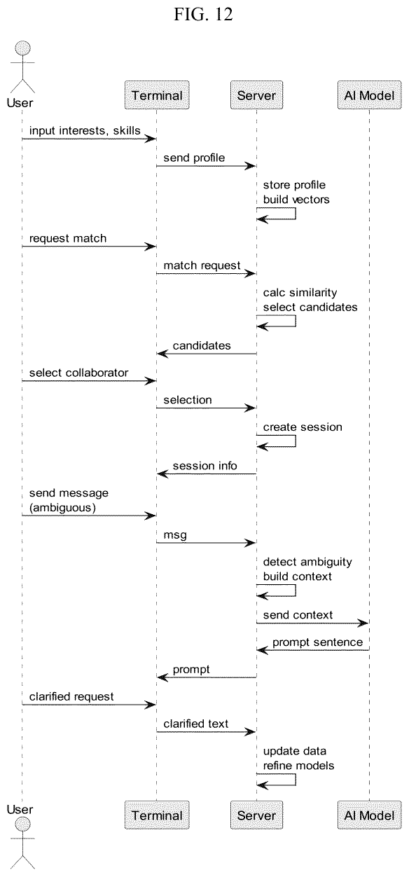

The following describes the processing flow using FIG. 12.

### Step 1:

User operates the terminal to input user interest information and user capability information.

User enters, for example, text strings such as “data analysis, machine learning” as interests and “Python, SQL” as capabilities into input fields displayed on the terminal.

The input of this step is raw text data typed or selected by the user on the terminal user interface.

The output of this step is a structured set of user-entered values held temporarily in the terminal memory, such as a set of interest terms and capability terms associated with the current user account.

### Step 2:

Terminal validates and formats the user interest information and the user capability information for transmission.

Terminal checks that mandatory fields are not empty, verifies that text lengths are within predefined limits, and optionally normalizes text (for example, by trimming whitespace or converting characters to a standard case).

Terminal then converts the validated data into a structured representation such as a key-value map in memory.

The input of this step is the raw text values captured in Step 1.

The output of this step is a structured and validated data object ready for network transmission, including, for example, a user identifier, a list of normalized interest tokens, and a list of normalized capability tokens.

### Step 3:

Terminal transmits the structured user interest information and user capability information to the server.

Terminal establishes a network connection through a communication interface and sends the structured data as a message to a predefined server endpoint.

The input of this step is the structured user data prepared in Step 2.

The output of this step is a network request containing the user interest information and user capability information delivered to the server, and a local transmission status stored on the terminal.

### Step 4:

Server receives the transmitted user interest information and user capability information and stores them in a storage device.

Server parses the received message, extracts the user identifier, and maps the incoming interest and capability terms to internal database fields.

Server inserts or updates corresponding records in data tables such as a user table, an interest table, and a capability table, and may create or update indices for faster retrieval.

The input of this step is the structured message received from the terminal over the network.

The output of this step is a set of persistent records in the storage device that represent the user's interest and capability profiles in a normalized, queryable form.

### Step 5:

Server generates feature vectors representing the user's interests and capabilities for similarity computation.

Server retrieves the stored interest and capability terms, applies preprocessing such as token normalization and mapping to vocabulary indices, and then applies a vectorization method (for example, TF-IDF or an embedding model) to convert the terms into numerical feature vectors.

Server may use a numerical computation library to perform matrix operations and to store the resulting vectors in memory or in a dedicated vector storage structure.

The input of this step is the normalized interest and capability records from the storage device.

The output of this step is at least one feature vector associated with the user, representing the user in a numerical space suitable for similarity calculations.

### Step 6:

Server retrieves feature vectors of other users and computes similarity scores.

Server queries the storage device to obtain feature vectors of other active users, loads them into memory, and applies a similarity function such as cosine similarity between the target user's vector and each candidate user's vector.

Server performs vector dot products and normalization operations to obtain a numeric similarity value for each candidate.

The input of this step is the target user's feature vector and a set of feature vectors for other users.

The output of this step is a list of candidate user identifiers with associated similarity scores, each score quantifying the degree of match between users.

### Step 7:

Server selects collaborator candidate users based on the computed similarity scores.

Server sorts the candidate list in descending order of similarity, applies filters such as activity status or exclusion rules, and then selects a specified number of top-ranked users.

Server may also apply threshold conditions to discard candidates whose similarity score falls below a minimum value.

The input of this step is the list of candidate user identifiers and similarity scores from Step 6.

The output of this step is a refined set of collaborator candidate users, each identified with a user identifier and associated profile data, stored temporarily in memory for response generation.

### Step 8:

Server transmits the collaborator candidate users to the terminal.

Server formats the candidate user information, including display name, key interests, and key capabilities, into a response message and sends this message over the network to the requesting terminal.

The input of this step is the refined set of collaborator candidate users selected in Step 7.

The output of this step is a response message received by the terminal that contains a structured description of multiple collaborator candidate users.

### Step 9:

Terminal presents the collaborator candidate users to the user and receives a user selection.

Terminal parses the received message, constructs a visual list on the display device, and shows for each candidate user items such as name, interests, and capabilities.

User reviews this list and selects at least one candidate (for example, by tapping or clicking an item on the screen).

The input of this step is the candidate user information received from the server in Step 8.

The output of this step is a user selection event stored in the terminal, indicating at least one selected collaborator candidate user.

### Step 10:

Terminal transmits the user's selection of a collaborator candidate user to the server.

Terminal packages the selected candidate's identifier together with the current user identifier into a structured message and sends this message over the network to a collaboration initiation endpoint on the server.

The input of this step is the user selection event recorded in Step 9.

The output of this step is a collaboration initiation request delivered to the server, containing the identifiers of the user and the selected collaborator candidate user.

### Step 11:

Server establishes a communication session between the user and the selected collaborator candidate user.

Server verifies both users'statuses, creates a new session record with a unique session identifier in the storage device, and registers both users as participants in the session.

Server initializes real-time communication channels, for example by associating both users'connections with the session identifier in a session management component.

The input of this step is the collaboration initiation request from the terminal in Step 10.

The output of this step is an active communication session state stored in the server and a session identifier that will be used to route real-time messages between terminals.

### Step 12:

Server notifies the terminals of the established communication session and enables real-time information exchange.

Server sends session start messages to the initiator's terminal and the collaborator's terminal, including the session identifier and relevant metadata.

Each terminal, upon receiving this message, opens or updates a communication interface (for example, a chat window) tied to the session identifier.

The input of this step is the active session state and the participant identifiers from Step 11.

The output of this step is synchronized session context at both terminals and ready state of real-time communication channels.

### Step 13:

User exchanges messages and content through the terminals during the communication session.

User types or records messages, files, or other content, and each terminal attaches the session identifier and sends the data to the server.

Server receives these messages, associates them with the session record, and forwards them to the other participant's terminal in real time.

The input of this step is user-generated communication content at each terminal, tagged with the session identifier.

The output of this step is real-time delivery of communication content to the counterpart terminal and an updated message history stored on the server.

### Step 14:

Server detects ambiguous request information within the user's communication content or input.

Server analyzes recent messages and user inputs associated with the session, using simple heuristics (for example, length, presence of vague expressions) or more advanced classifiers, to determine whether the user's current request lacks specificity.

Server identifies text segments such as “I want to do some machine learning projects, but I'm not sure what exactly” as ambiguous request information.

The input of this step is the recorded dialogue content and inputs from the ongoing session in the storage device or memory.

The output of this step is a tagged portion of text recognized as ambiguous request information and linked to the user, the session, and the time of occurrence.

### Step 15:

Server constructs context information for the generative AI model based on the ambiguous request information and stored profile data.

Server retrieves the user's interest and capability profiles from the storage device, obtains recent dialogue history associated with the session, and combines these with the detected ambiguous request.

Server encodes this combined information into a structured context, for example by concatenating segments into a prompt template or by marking sections (such as system instructions, user profile, and recent dialogue).

The input of this step is the ambiguous request information from Step 14 and the stored user interest information, user capability information, and dialogue history.

The output of this step is a context representation suitable for input to the generative AI model, including clearly separated sections for instructions and data.

### Step 16:

Server provides the constructed context information to the generative AI model and generates a prompt sentence.

Server tokenizes the context text according to the generative AI model's tokenizer, sets model parameters (for example, temperature and maximum token length), and submits the token sequence to the model.

The generative AI model processes the input sequence using its internal neural network layers and outputs a sequence of tokens representing a prompt sentence.

The input of this step is the structured and tokenized context information prepared in Step 15.

The output of this step is at least one generated prompt sentence in text form, for example:
“Please describe what type of data (for example, text, images, or numerical data) you want to work with, and what kind of result (for example, prediction, classification, or recommendation) you expect from the machine learning model.”

### Step 17:

Server post-processes the generated prompt sentence and transmits it to the terminal.

Server converts the token sequence back into a text string, checks length and inappropriate content, and attaches metadata such as the session identifier and message type (clarification prompt).

Server sends this message over the network to the relevant terminal associated with the user who issued the ambiguous request.

The input of this step is the raw generated prompt sentence and related metadata from Step 16.

The output of this step is a prompt sentence message delivered to the user's terminal as part of the ongoing communication session.

### Step 18:

Terminal displays the prompt sentence to the user and receives a clarified response.

Terminal receives the prompt sentence message and renders it in the communication interface, visually distinguishing it as a system-generated guidance message.

User reads the prompt sentence and enters a more detailed description, for example: “I want to analyze numerical sales data from an e-commerce site and build a model to predict future sales.”

The input of this step is the prompt sentence message from the server in Step 17.

The output of this step is clarified request information entered by the user and stored briefly in the terminal before transmission to the server.

### Step 19:

Terminal transmits the clarified request information to the server.

Terminal packages the clarified text together with the session identifier and user identifier and sends this package to the server over the network as an update to the session.

The input of this step is the clarified request information captured from the user in Step 18.

The output of this step is a clarified request message stored or queued at the server for further processing.

### Step 20:

Server updates the user and session data using the clarified request information and optionally refines matching or pattern extraction.

Server records the clarified request as part of the dialogue history and may update user preference fields or derived feature vectors to reflect the new specificity.

Server may recompute similarity scores or apply latent pattern extraction algorithms using the clarified data to propose additional collaborator candidate users or information resources aligned with the refined requirements.

The input of this step is the clarified request message received in Step 19 and the existing stored user and session data.

The output of this step is an updated user and session representation in the storage device, refined feature vectors and pattern models in memory, and, when applicable, new or updated recommendations ready for presentation to the terminal.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented interaction platforms that collect user requests and provide responses typically assume that the user can express a concrete and well-structured request at the outset. In practice, however, many user inputs are abstract, ambiguous, and low in resolution, such as vague desires, loosely defined goals, or unstructured ideas. Conventional systems generally perform simple keyword matching, fixed-form questionnaires, or rule-based branching, which are not capable of dynamically clarifying such abstract requests. As a result, these systems often produce low-quality matches, irrelevant recommendations, and inefficient user interactions.

Furthermore, in existing architectures, the analysis of user interest information, capability information, and emotional state is often performed in isolated components without an integrated dialogue control mechanism that incrementally refines the request. Even if a machine learning model is employed, it is frequently used as a one-shot classifier or recommender, rather than as part of a controlled, iterative clarification process. This leads to underutilization of computational resources and does not fully exploit advances in natural language processing and generative AI models.

In addition, known systems generally do not use generative AI models in a structured way for generating prompt sentences and clarification questions, nor do they maintain a dialogue state that is explicitly managed in memory to transform an abstract request into concrete target information. The absence of a systematic mechanism for constructing, updating, and reusing prompt sentences means that generative AI capabilities are applied in an ad hoc manner, resulting in unstable behavior, inconsistent results, and difficulty in scaling to large numbers of users and diverse domains.

Moreover, conventional systems often lack a tightly coupled pipeline in which clarified target information is directly used to drive subsequent computational processes such as similarity-based retrieval and matching of collaborator profiles or information source profiles. Without an explicit computational interface between the dialogue-driven clarification process and the downstream matching process, the quality and relevance of suggested collaborators or information sources remain limited.

Accordingly, there is a need for a computer-implemented technique that improves the way a processor acquires and stores abstract request information, controls a generative AI model via systematically constructed prompt sentences, maintains and updates a dialogue state in memory, and programmatically determines when a request has become sufficiently concrete to trigger a structured matching process. Such a technique should improve the efficiency, reliability, and accuracy of the underlying computer system itself, by reducing redundant interactions, stabilizing model behavior through controlled prompts, and optimizing database access and similarity computation based on concretized target information.

The specific processing by the specific processing unit 290 of the data processing device 12 in Example 2 is realized by the following means.

The present invention provides a server comprising a processor and a memory, the processor being configured to acquire, via a terminal, abstract request information input by a user and store the abstract request information as request data in the memory; to generate, based on the request data, a prompt sentence that instructs a generative AI model to perform at least analysis of interest information and capability information of the user, clarification of contents of a request of the user, analysis of an emotional state of the user, and generation of proposal information; to input the prompt sentence to the generative AI model and cause the generative AI model to analyze the abstract request information to identify missing information and to generate specific question sentences for stepwise clarification of the contents of the request; to transmit the specific question sentences to the terminal and cause the terminal to present the specific question sentences to the user; to acquire, via the terminal, answer information input by the user in response to the specific question sentences, store the answer information in association with the request data in the memory, and update a dialogue state for converting the abstract request information into concrete target information; to determine, on the basis of the request data and the answer information, a degree of concretization of the contents of the request, and, when the contents of the request are determined to be insufficient, to update the prompt sentence to be input to the generative AI model and cause the generative AI model to generate additional specific question sentences, and, when the contents of the request are determined to be sufficiently concrete, to automatically extract collaborator information or related information source information on the basis of the request data and the answer information; and to transmit the concrete target information and the collaborator information or the related information source information to the terminal and cause the terminal to present the concrete target information and the collaborator information or the related information source information to the user. This enables the computer system itself to more efficiently transform low-resolution, abstract user inputs into high-resolution, structured target information through controlled interactions with a generative AI model, to manage dialogue state and prompt sentences in a systematic manner, and to perform more accurate and computationally effective matching of collaborators or information sources based on the concretized target information.

The term “abstract request information” refers to user-provided information that expresses a vague, ambiguous, or low-resolution intention, desire, or goal, without sufficient specificity to directly perform matching or generate concrete results.

The term “request data” refers to data stored in a memory that represents at least the abstract request information input by a us er, optionally together with associated metadata such as timestamps, user identifiers, and dialogue identifiers.

The term “terminal” refers to an information processing apparatus operated by a user, such as a communication device, a computing device, or a display device, that is configured to transmit information to and receive information from a server via a communication network.

The term “prompt sentence” refers to text data that encodes instructions or context to be provided as input to a generative AI model so as to control processing by the generative AI model, including analysis, clarification, or generation of information.

The term “generative AI model” refers to a machine learning model that processes input data such as natural language text and generates output data such as text, questions, summaries, or recommendations, based on statistical patterns learned from training data.

The term “interest information” refers to information representing at least a preference, inclination, or field of concern of a user, which may be derived from the abstract request information, answer information, or other user-related data.

The term “capability information” refers to information representing at least a skill, experience, qualification, or competence level of a user, which may be used to analyze suitability for particular collaborators or activities.

The term “emotional state” refers to information indicating at least an affective or psychological condition of a user, such as stress, motivation, satisfaction, or frustration, inferred from user inputs or other behavioral signals.

The term “proposal information” refers to information generated by the system that suggests at least an action, recommendation, or option to the user in response to the contents of the request and the clarified information.

The term “specific question sentences” refers to natural language expressions generated by the generative AI model that are configured to solicit concrete, detailed answers from the user for the purpose of clarifying the contents of the request.

The term “answer information” refers to information representing responses input by the user to the specific question sentences, the responses being used to refine or concretize the abstract request information.

The term “dialogue state” refers to structured information stored in a memory that represents at least a current stage of interaction between the user and the system, including the request data, specific question sentences, answer information, and a status of clarification.

The term “concrete target information” refers to structured information derived from the abstract request information and the answer information, the structured information representing a sufficiently specific and actionable description of a user's goal or need.

The term “degree of concretization” refers to an evaluation measure indicating how specifically and sufficiently the contents of the request have been clarified, based on at least the request data and the answer information.

The term “collaborator information” refers to information representing at least attributes of candidate parties, such as entities or individuals, that may cooperate with the user in relation to the concrete target information.

The term “related information source information” refers to information representing at least attributes of data sources, documents, services, or other resources that are relevant to the concrete target information.

The term “profile information” refers to structured attribute information associated with a collaborator or an information source, including items such as domain, region, scale, expertise, or other characteristics used for matching.

The term “similarity” refers to a measure computed by the system that quantitatively represents a degree of correspondence or closeness between the concrete target information and profile information, based on a predetermined similarity calculation method.

In one embodiment, a server, a terminal, and a user cooperate to implement the invention. The server includes at least one processor, a main memory, a nonvolatile storage device, and a network interface. The processor may be a general-purpose central processing unit or a graphics processing unit. The main memory may be dynamic random access memory, and the nonvolatile storage device may be a magnetic disk, a solid-state drive, or another persistent storage device. The network interface may be an Ethernet controller connected to a packet-switched network. The server executes an operating system such as a general-purpose server operating system, and an application program configured to implement the functions described in the claims. The terminal includes at least a processor, a memory, a display unit, an input unit such as a touchscreen or keyboard, and a communication unit such as a wireless modem. The terminal executes an operating system such as a mobile or desktop operating system and an application for user interaction, which may be implemented as a native application or a web browser application.

The server stores, in the nonvolatile storage device, executable instructions that cause the processor to perform a plurality of functional operations that include management of abstract request information, generation and control of prompt sentences, interaction with a generative AI model, maintenance of a dialogue state, and extraction of collaborator information or related information source information based on concrete target information. The generative AI model may be provided as a remote inference service accessible through an application programming interface or as a locally hosted trained model executed on the server by means of a machine learning framework such as a tensor-based computation library.

The server stores, in the memory and the nonvolatile storage device, a plurality of data structures. These data structures include at least a request table for storing request data, a dialogue state table for storing dialogue context, a question table for storing specific question sentences, an answer table for storing answer information, and a profile table for storing profile information of collaborators or information sources. In one example, the request table holds fields such as a request identifier, a user identifier, an abstract request text, a creation timestamp, and a status indicating a degree of concretization. The dialogue state table may hold a reference to the request identifier, a list of question identifiers, a list of answer identifiers, and a state flag indicating a current stage of clarification. The profile table may store, for each candidate collaborator or information source, a plurality of attribute fields such as domain category, geographical region, organization scale category, skill tags, and historical performance metrics, and may also store a vector representation computed by an embedding model.

The server implements the generative AI model as a parameterized neural network configured to process natural language. In one embodiment, the generative AI model is a transformer-based network including a plurality of encoder-decoder layers or decoder-only layers. Each layer includes multi-head self-attention submodules and feed-forward submodules. The model parameters include weight matrices for attention projection, feed-forward layers, and layer normalization. The server stores these parameters in the nonvolatile storage device and loads them into the main memory at inference time. The server executes, on the processor or a GPU, matrix multiplication operations, non-linear activation functions, and normalization operations defined by the transformer architecture. During operation, the server tokenizes a prompt sentence into a sequence of discrete tokens using a predefined vocabulary and converts these tokens into embedding vectors. The server then propagates these vectors through the transformer layers to obtain context-aware internal representation vectors for each token. The server selects output token probabilities based on a softmax function and generates new tokens sequentially until an end-of-sequence condition is met or a token limit is reached.

The server may train the generative AI model in advance using a supervised learning approach on a corpus of natural language data. In training, the server computes, for each training example, a loss value such as cross-entropy between predicted token distributions and ground-truth tokens.

The server updates the model parameters by applying an optimization algorithm, such as stochastic gradient descent with adaptive moment estimation, to minimize the loss over the training data. The server may apply regularization techniques such as dropout and may use data augmentation of text examples to improve generalization. The training procedure is performed offline prior to deployment; however, the server may also implement fine-tuning or continual learning for domain adaptation using additional dialogue logs collected during operation.

The server uses the generative AI model in a manner distinct from simple automation of human dialogue. The server supplies to the generative AI model specifically constructed prompt sentences that encode a structured dialogue control policy. For example, the server may generate a prompt sentence such as:
“The user says: ‘I want to find a new business partner.’ Generate 3-5 specific questions to clarify the user's intent. Focus on industry, region, business size, and collaboration style. Output only the questions.”

In another example, the server may generate a prompt sentence such as:
“Original user request: ‘I want to find a new business partner.’

Clarified information: industry=IT/SaaS, region=Japan, company size=small to medium, collaboration type=product co-development.

Determine if this information is sufficiently specific to start matching collaborators. If not, list missing aspects and propose 2 additional clarification questions. Output either ‘sufficient’ or ‘insufficient’followed by questions if needed.”

By encoding specific roles, constraints, and output formats into prompt sentences, the server controls the internal computation of the generative AI model so that the model focuses on clarification operations instead of unrestricted text generation. This leads to more predictable outputs, reduces the need for post-processing, and thus reduces processing time and resource consumption on the server.

The server performs explicit feature extraction from the abstract request information and the answer information to compute a degree of concretization. For this purpose, the server stores a set of target attributes such as domain category, region, organization scale, time frame, resource constraints, and collaboration type in a configuration data structure. The server maps tokens of the answer information into these attributes by applying pattern matching, named-entity recognition, and classification algorithms implemented using additional models such as sequence labeling networks or rule-based extractors. The server then evaluates a completeness vector where each attribute is assigned a completeness score. When a predefined threshold is not met for one or more attributes, the server determines that the request remains insufficiently concrete and generates a new prompt sentence to obtain additional specific question sentences targeting the incomplete attributes. This attribute-level completeness evaluation is not performed by human operators but rather by the processor executing explicit computation over structured representations, thereby improving consistency and enabling faster convergence to a fully specified request.

The server controls data flow between the dialogue components and the matching components in a manner that improves computational efficiency. The server represents both the concrete target information and each profile in the profile table as numeric vectors in a shared embedding space produced by an embedding network such as a dual-encoder or a sentence-embedding model. The server computes these vectors in advance for stored profiles and caches them in the memory. For incoming concrete target information, the server computes a target vector and then executes a similarity search using operations such as dot product or cosine similarity between the target vector and the cached profile vectors. The server may organize the profile vectors in an index structure, such as an approximate nearest neighbor index, to reduce query time. As a result, the matching process can handle a large number of profiles with reduced latency compared to naïve linear scanning.

The server, by maintaining the dialogue state in a structured form, minimizes redundant communication with the terminal and reduces network traffic. For example, the server stores, in the dialogue state table, a minimal set of data needed for the next interaction step, such as identifiers of unanswered questions and the current completeness vector. This allows the server to compute, prior to generating a prompt sentence, which attributes remain unresolved and to limit the next prompt sentence to only those missing aspects. Consequently, the generative AI model generates only necessary clarification questions, reducing the number of tokens processed by the model and thus reducing inference time and communication overhead between the server and the model provider.

The terminal operates as an interface device controlled by the server. The terminal presents specific question sentences on the display unit and captures user input via the input unit. The terminal may implement client-side validation and simple formatting functions, but the main dialogue control logic and data analysis are executed by the server. By offloading the intensive computation to the server, the system can run on a wide variety of terminals, including resource-constrained devices, while still providing advanced clarification and matching capabilities.

The user interacts with the terminal by entering an initial abstract request and by answering specific question sentences. For example, the user may enter “I want to find a new business partner” as an initial request. After seeing the questions such as “In which industry are you looking for a business partner?” and “In which country or region should the partner be located?”, the user may provide concrete answers. The server accumulates these answers in the dialogue state and uses them to update the concrete target information and the completeness vector.

The server, by executing the described algorithms and maintaining the described data structures, achieves several technical effects. First, the server reduces the number of generative inference calls and the number of tokens per call by controlling the generative AI model via precise prompt sentences and by targeting only unresolved aspects of the request. This leads to improved processing speed and reduced computational load, which are technical improvements in the operation of the computer system. Second, the server improves the accuracy of matching by constructing concrete target information in a structured form and by using vector-based similarity search over structured profile information, which reduces mismatches and false positives compared to simple keyword-based matching. Third, the server improves data management by organizing dialogue state, request data, and profile data into separate but linked tables with clear identifiers, which facilitates efficient access patterns, reduces redundant data, and simplifies caching strategies.

The server also implements non-conventional processing for generating and using prompt sentences. Unlike typical human-driven questioning, where a human operator decides which question to ask next, the server automatically constructs prompt sentences based on internal completeness evaluations and attribute-level gaps. The server encodes such evaluation outcomes into prompt sentences in a machine-targeted format, such as including explicit instructions on which attributes are missing and specifying the allowed output style. This non-human-centric prompt generation strategy allows the server to integrate rule-based state control with neural generation, resulting in more robust and reproducible behavior.

In another embodiment, the server may apply different generative AI models or different configurations of the same model for different tasks. For example, the server may use a first model specialized in question generation and a second model specialized in summarization. In this case, the server stores in the configuration data structures separate prompt templates for each task and dynamically selects a template and a model identifier depending on the current state of the dialogue. For instance, after completion of the clarification phase, the server may generate a summarization prompt such as:
“Summarize the following user request profile in 2-3 natural sentences for the user:
goal: find a new business partner
industry: IT/SaaS
region: Japan
company size: small to medium
collaboration type: co-develop a new product
budget: around 10 million
experience preference: partner with domestic and some international experience”

The server then obtains a natural language summary that can be displayed to the user as an explanation of what the system has understood. This multi-model, multi-prompt configuration further improves flexibility without imposing additional complexity on the user.

In yet another embodiment, the server may incorporate reinforcement learning signals derived from user feedback into the prompt construction process. For example, when the user indicates that suggested collaborators are not relevant, the server may record this fact in the dialogue state and adjust internal weights or selection heuristics for future prompt construction, such as requesting the generative AI model to emphasize different attributes or to ask additional clarifying questions regarding previously neglected aspects. This adaptive control mechanism further enhances the technical performance of the system by reducing repeated mismatches over time.

The server may also enforce deterministic decoding strategies when generating specific question sentences, such as using low-temperature sampling or greedy decoding, to minimize variance in outputs and to align with the structured nature of the dialogue. By doing so, the server can cache frequently used prompt-output pairs and reuse them in similar scenarios, further decreasing computational cost and latency.

By tightly coupling the generative AI model, prompt sentence management, dialogue state management, and similarity-based matching in the described manner, the server implements more than mere automation of human judgment. The server modifies the overall functioning of the computer system by introducing structured data representations, explicit completeness evaluation, and controlled generative processing that collectively improve processing speed, accuracy of matches, management of conversational data, and efficient use of computational and communication resources.

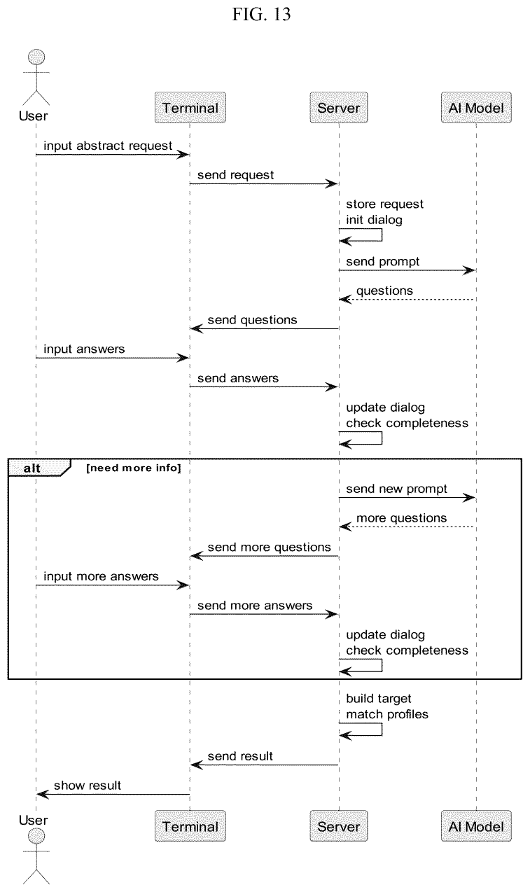

The following describes the processing flow using FIG. 13.

### Step 1:

User operates the terminal to input abstract request information.

User views an input screen displayed on the terminal and enters an abstract request, such as “I want to find a new business partner,” using a keyboard or touchscreen. The input is raw text characters supplied by the user. The output is a text string held in the terminal's working memory representing the abstract request information.

### Step 2:

Terminal structures and stores the abstract request information locally.

Terminal receives the text string from the input component and wraps it into a request object that includes at least the request text, a temporary request identifier, and a timestamp. The input is the raw text string entered by the user. The terminal performs data formatting, such as trimming whitespace and normalizing character encoding, and generates a structured record. The output is a structured request object ready for transmission.

### Step 3:

Terminal transmits the abstract request information to the server.

Terminal takes the structured request object as input and serializes it into a data format such as a JSON-formatted message. Terminal then sends the serialized message via a communication stack over a network to a predefined server endpoint. The main data operation is encapsulating the request object into a network packet sequence. The output is a network message delivered to the server containing the abstract request information.

### Step 4:

Server receives and records the abstract request as request data.

Server takes the incoming network message as input, decodes the transport and application protocol headers, and deserializes the payload from the serialized format into an internal data structure. Server then stores the request data in a request table of a storage device, assigning a persistent request identifier and recording user-related metadata. The data operation includes parsing, identifier generation, and insertion into a persistent data structure. The output is a stored request record and an internal request identifier.

### Step 5:

Server initializes a dialogue state associated with the request.

Server uses the stored request record as input and creates a dialogue state entry containing the request identifier, an empty list of question identifiers, an empty list of answer identifiers, and an initial concretization status flag. Server writes this dialogue state into a dialogue state table. The data operation includes allocation of a new dialogue context structure and linking it to the request identifier. The output is a stored dialogue state ready for subsequent processing.

### Step 6:

Server generates a first prompt sentence for the generative AI model.

Server takes the abstract request text and the initial dialogue state as input and constructs a prompt sentence by concatenating fixed instruction text and the request text. For example, the server may generate:
“The user says: ‘I want to find a new business partner.’ Generate 3-5 specific questions to clarify the user's intent. Focus on industry, region, business size, and collaboration style. Output only the questions.”

The data operation includes string template expansion, insertion of the request text, and optional insertion of configuration parameters such as number of questions. The output is a complete prompt sentence string.

### Step 7:

Server submits the prompt sentence to the generative AI model.

Server takes the prompt sentence as input and converts it into token identifiers using a tokenizer associated with the generative AI model. Server packs these token identifiers into a model input structure and transmits this structure either to a local inference engine or to an external inference service via a network interface. The data operation includes tokenization, encoding into numerical representations, and request construction. The output is an inference request delivered to the generative AI model.

### Step 8:

Server obtains specific question sentences from the generative AI model.

Server receives, as input, the model output tokens that have been computed by the generative AI model based on the prompt sentence. Internally, the generative AI model has applied transformer layers that compute attention scores, matrix multiplications, and nonlinear activations to produce probability distributions over possible next tokens. Server decodes the output token sequence back into a natural language string. The data operation includes sequence decoding, removal of special tokens, and text normalization. The output is a text block containing specific question sentences.

### Step 9:

Server parses and structures the specific question sentences.

Server takes the text block with question sentences as input and separates it into individual questions by detecting line breaks, numbering patterns, or punctuation. Server removes unnecessary numbering characters and leading/trailing whitespace and creates question records, each containing question text, a reference to the request identifier, and a question order. The data operation includes text splitting, pattern matching, and creation of structured records. The output is a set of structured question entries.

### Step 10:

Server stores the specific question sentences and updates the dialogue state.

Server takes the structured question entries as input and writes each entry into a question table, assigning a question identifier to each question. Server then updates the dialogue state entry to append the new question identifiers and to update the concretization status to indicate that clarification is in progress. The data operation includes database insertion and update operations linking question identifiers to the dialogue state. The output is a persistent set of question records and a refreshed dialogue state.

### Step 11:

Server transmits the specific question sentences to the terminal.

Server takes the structured question entries as input and formats them into a response message that includes the request identifier, a dialogue identifier, and the question texts. Server serializes this message into a transfer format and sends it to the terminal over the network. The data operation includes serialization and network packet transmission. The output is a network response carrying the specific question sentences to the terminal.

### Step 12:

Terminal receives and displays the specific question sentences.

Terminal takes the server response message as input, deserializes the payload into an internal structure containing question identifiers and question texts, and stores these structures in local memory. Terminal generates user interface elements for each question, such as labels and input fields, and renders them on the display. The data operation includes JSON parsing or similar deserialization, mapping of question objects to UI components, and triggering of display updates. The output is a visible set of questions on the terminal screen and a local mapping between UI elements and question identifiers.

### Step 13:

User inputs answer information for the specific question sentences.

User views each displayed question and uses the input unit of the terminal to type or select an answer, such as “IT industry, especially SaaS” or “Japan.” The input consists of one or more answer texts associated with respective questions. The output is a collection of raw answer strings made available to the terminal application.

### Step 14:

Terminal structures and validates answer information.

Terminal takes the raw answer strings and corresponding question identifiers as input and builds an answer object list where each answer object includes a question identifier, answer text, and a local timestamp. Terminal may perform simple validation, such as checking that the answer is not empty and does not exceed a maximum length. The data operation includes pairing question identifiers with answer texts and discarding or flagging invalid answers. The output is a validated and structured answer list.

### Step 15:

Terminal transmits the answer information to the server.

Terminal takes the structured answer list as input, serializes it into a response message that also includes the request identifier and the dialogue identifier, and sends this message over the network to the server. The data operation includes serialization of the answer list and encapsulation into network packets. The output is a transmitted message containing answer information addressed to the server.

### Step 16:

Server records the answer information and associates it with the request.

Server takes the message containing the answer information as input, deserializes the payload, and obtains the list of answers with question identifiers. Server inserts each answer into an answer table with references to the corresponding request identifier and question identifier. Server then updates the dialogue state entry to append the new answer identifiers and to flag the associated questions as answered. The data operation includes database insertion and update operations linking answers with questions and the dialogue context. The output is a persistent set of answer records and an updated dialogue state.

### Step 17:

Server evaluates a degree of concretization of the request.

Server takes the request data and all associated answer information as input and computes a completeness vector over predefined attributes such as industry, region, organization scale, collaboration type, and budget. Server may perform text classification and entity extraction on the answer texts using statistical models or rule sets to fill attribute fields. The data operation includes text feature extraction, mapping of tokens to attribute categories, and aggregation into a completeness vector. The output is a degree-of-concretization value and a list of unresolved attributes.

### Step 18:

Server decides whether additional clarification questions are needed.

Server takes the degree-of-concretization value and the list of unresolved attributes as input and compares them to predetermined thresholds and rules. If one or more attributes remain unresolved, server sets a flag in the dialogue state indicating that clarification is incomplete. If all required attributes are filled with acceptable confidence, server sets the flag to indicate that clarification is complete. The data operation includes comparison operations and logical evaluation against configuration rules. The output is a decision result indicating either “clarification required” or “clarification sufficient.”

### Step 19:

Server constructs an updated prompt sentence when clarification is insufficient.

When clarification is insufficient, server takes the unresolved attributes, the original abstract request, and prior answer information as input and generates a new prompt sentence that instructs the generative AI model to generate additional specific questions focused on the missing attributes. For example, the server may generate:
“Original user request: ‘I want to find a new business partner.’

Clarified information: industry =IT/SaaS, region =Japan, company size =small to medium, collaboration type =product co-development.

Identify any remaining missing information such as budget or required experience level, and generate 2 additional clarification questions. Output only the questions.”

The data operation includes string formatting that explicitly enumerates known attributes and missing fields. The output is an updated prompt sentence ready for another model inference.

### Step 20:

Server interacts again with the generative AI model to obtain additional questions.

Server takes the updated prompt sentence as input, tokenizes it, and sends it to the generative AI model as in the earlier interaction. The generative AI model processes the tokens through its network layers, and server receives new output tokens corresponding to additional specific question sentences. The data operation includes forward propagation of embeddings through the model and decoding of the generated token sequence. The output is a new set of additional specific question sentences for unresolved attributes.

### Step 21:

Server repeats question presentation and answer collection until clarification is sufficient.

Server takes the additional questions as input, structures and stores them, and transmits them to the terminal. Terminal displays the questions, user inputs answers, and terminal sends answer information back to the server. Server records these answers and re-evaluates the degree of concretization as described in previous steps. The data operation includes iterative updating of the dialogue state and recomputation of the completeness vector after each cycle. The output of the repeated cycles is a fully clarified set of attributes forming concrete target information.

### Step 22:

Server generates concrete target information from the clarified data.

Server takes the final request data and all validated answer information as input and constructs a structured target profile that includes fields such as goal description, industry category, region, organization scale, collaboration type, budget range, and experience preference. The data operation includes merging textual descriptions, mapping answers to categorical codes, and storing the resulting structure in a dedicated target profile table. The output is a concrete target information record uniquely associated with the request.

### Step 23:

Server performs similarity-based matching using profile information.

Server takes the concrete target information and the stored profile information of collaborators or information sources as input. Server computes or retrieves vector embeddings for both the target profile and each stored profile, using an embedding model that transforms attribute values into fixed-length numeric vectors. Server then calculates similarity scores, for example by computing dot products or cosine similarity, between the target vector and each profile vector. The data operation includes vector generation, vector normalization, and similarity score computation. The output is a ranked list of candidate collaborators or information sources sorted by similarity score.

### Step 24:

Server compiles collaborator information or related information source information to be presented.

Server takes the ranked candidate list as input and selects a subset of candidates based on similarity thresholds or top-N selection. Server then retrieves detailed profile fields for each selected candidate, such as name category, domain category, location category, and contact information, and assembles these fields into output records associated with the request identifier. The data operation includes filtering, sorting, and joining operations across the profile table. The output is a structured result set of collaborator information or related information source information.

### Step 25:

Server prepares final response information including concrete target information and recommendations.

Server takes the concrete target information and the selected candidate records as input and constructs a response package that summarizes the clarified goal and lists the recommended collaborators or information sources. Server may optionally generate an explanatory text by composing a short narrative based on the target profile fields. The data operation includes text assembly, field formatting, and encapsulation of structured result records. The output is a final response dataset ready to be sent to the terminal.

### Step 26:

Server transmits the final response information to the terminal.

Server takes the final response dataset as input, serializes it into a message containing the concrete target information and the recommendation list, and sends this message over the network to the terminal. The data operation includes serialization, header attachment, and network transmission. The output is a delivered message containing the final clarified result and associated recommendations at the terminal.

### Step 27:

Terminal displays the concrete target information and recommendations to the user.

Terminal takes the received final response message as input, deserializes it into internal structures, and updates the user interface to show the clarified goal description and a list of recommended collaborators or information sources. Terminal may create interactive elements that allow the user to inspect additional details or initiate contact actions. The data operation includes mapping structured data fields to display components and refreshing the display. The output is a visual presentation that enables the user to understand the concretized request and available options.

### Step 28:

User reviews the presented information and optionally initiates further actions.

User observes the clarified goal and recommended collaborators or information sources displayed on the terminal and may decide to follow up, for example by selecting a candidate to view more details or by starting a communication process. The input for the user is the display content generated by the terminal, and the output is additional user interaction events that the terminal can forward to the server for further processing if needed.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information recommendation and matching systems rely on manually designed rules or monolithic machine learning pipelines that map user inputs directly to recommended items. Such systems exhibit several technical shortcomings in the context of modern, interactive, natural-language interfaces.

First, conventional systems handle user requests as static, one-shot queries. When a user provides a low-resolution request expressed in natural language (for example, short and vague text), the system typically applies simple keyword matching or shallow intent classification. These approaches do not dynamically reformulate the request into a machine-interpretable representation, and therefore cannot efficiently disambiguate the user's intent. As a result, the system often produces irrelevant or low-precision results, and the underlying computation wastes processing and storage resources by retrieving and scoring large numbers of unsuitable candidates.

Second, conventional systems generally separate natural language generation from core recommendation logic, or do not exploit generative models to drive the control flow of the interaction. Even when a generative AI model is present, it is usually used only to produce user-facing text, without structured integration with user attribute data, behavior data, and emotion data. This leads to a fragmented architecture in which there is no systematic way to generate machine-targeted prompt sentences that condition the generative model on internal state. As a consequence, the system cannot effectively use the generative AI model to iteratively refine the representation of the user request and to reduce the computational search space for recommendation.

Third, conventional systems either ignore user emotional state or treat it as an auxiliary display-level element that does not participate in the core data processing pipeline. Typical implementations do not feed emotion estimates into the feature vector processed by the recommendation model, and they do not generate prompt sentences for the generative model that explicitly condition on emotional state. As a result, the system fails to adapt ranking and generation to the user's current psychological context, which in turn reduces the effectiveness of recommendation, causes unnecessary recomputation of unsatisfactory results, and degrades the user interaction loop.

Fourth, logs of user responses, selections, and operation histories are often stored in an unstructured manner and are not tightly coupled to the prompt sentences, generative outputs, and recommendation decisions that produced them. This weak coupling makes it technically difficult to retrain or fine-tune recommendation models and emotion analysis models in a way that reflects how generative prompts influenced user behavior. As a result, the system cannot efficiently improve its internal models based on the full, causally relevant context, and the computational pipeline remains suboptimal over time.

Accordingly, there is a need for a technical architecture that integrates natural language processing, generative AI models, recommendation models, and emotion analysis models in a unified control loop. The architecture should generate structured prompt sentences for machine-targeted generative processing, use the generated outputs to clarify low-resolution requests and construct rich feature vectors including emotional state, and update internal models based on explicitly logged interactions. By doing so, the system can technically improve the efficiency and accuracy of the underlying computer-implemented recommendation and matching functions, reduce unnecessary compute operations, and provide more relevant and stable outputs for a given amount of processing resources.

The specific processing by the specific processing unit 290 of the data processing device 12 in Application Example 2 is realized by the following means.

The present invention provides a server comprising a processor and a storage device, the processor being configured to analyze user request information using natural language processing to determine whether the request is low-resolution, to extract intention information and keyword information, to generate first prompt sentences for input to a generative information processing model based on the extracted information and user attribute and behavior information stored in the storage device, to transmit the first prompt sentences to the generative information processing model and obtain question sentences and candidate proposal sentences for clarifying the low-resolution request, to acquire user response information to the question sentences and integrate the user response information with the user attribute and behavior information so as to generate feature information for a recommendation model, to cause the recommendation model to calculate evaluation values for candidate objects and select one or more candidate objects based on the evaluation values, to input the user response information and dialogue history information into an emotion analysis model to estimate a user emotional state and include the estimated emotional state in the feature information used for selection of the candidate objects, to generate second prompt sentences for input to the generative information processing model based on the selected candidate objects, the user attribute and behavior information and the user emotional state, to obtain natural-language proposal sentences from the generative information processing model and output the natural-language proposal sentences to a user interface apparatus, and to record user selection information and operation history information in the storage device as user behavior information and update at least one of the recommendation model and the emotion analysis model using the user behavior information as learning data. This enables the computing system to close a technical feedback loop in which low-resolution user requests are programmatically clarified via machine-targeted prompt sentences, recommendation and emotion models operate on enhanced feature vectors that include dynamically estimated emotional state, and the models are retrained based on structured logs that bind prompts, generated outputs, selections and behavior, thereby improving the accuracy, efficiency, and stability of computer-implemented recommendation and matching processing.

The term “information processing apparatus” refers to an electronic device, such as a computing device or terminal, that is configured to acquire input from a user, transmit the input to a server, and present output from the server to the user.

The term “user” refers to a human operator or group of human operators who interact with the system by providing request information, responses, selections, and other inputs.

The term “request information” refers to data representing a user's request, expressed for example as natural-language text or equivalent input, that indicates a need, desire, or query to be processed by the system.

The term “low-resolution request” refers to request information that lacks sufficient specificity, context, or constraint to enable direct, high-precision recommendation or matching without further clarification.

The term “natural language processing” refers to a set of computational techniques executed by a processor to analyze natural-language expressions, including at least one of tokenization, part-of-speech tagging, syntactic analysis, semantic analysis, intent detection, keyword extraction, and entity recognition.

The term “intention information” refers to data representing an inferred intent, purpose, or objective of the user, derived from the request information by natural language processing.

The term “keyword information” refers to data representing one or more salient words, phrases, or entities extracted from the request information and used as features or constraints in subsequent processing.

The term “storage device” refers to a memory subsystem, such as a non-transitory computer-readable storage medium, that stores data including user attribute information, user behavior information, model parameters, prompt sentences, and generated outputs.

The term “user attribute information” refers to data describing characteristics of a user, including at least one of profile data, demographic data, interest data, skill data, preference data, and historical configuration data.

The term “user behavior information” refers to data representing actions performed by the user in relation to the system, including at least one of request histories, response histories, selection histories, click histories, browsing histories, purchase histories, event participation histories, and operation logs.

The term “generative information processing model” refers to a machine-implemented model, such as a generative AI model, configured to receive a prompt sentence as input and to generate natural-language or structured output based on learned parameters.

The term “prompt sentence” refers to machine-targeted instruction information, expressed as natural-language text or equivalent representation, that conditions a generative information processing model to perform a specified task and generate a corresponding output.

The term “question sentence” refers to an output sentence generated by the generative information processing model that is configured to solicit additional information from the user for clarifying a low-resolution request.

The term “candidate proposal sentence” refers to a sentence generated by the generative information processing model that proposes one or more candidate objects or options to the user, based on current analysis of the request.

The term “user response information” refers to data representing an answer, comment, or selection provided by the user in response to a question sentence or proposal presented by the system.

The term “feature information” refers to a structured set of values, such as a feature vector, derived from at least one of user attribute information, user behavior information, user response information, and user emotional state, for input to a machine-learning model.

The term “recommendation model” refers to a machine-learning model configured to receive feature information as input and to output evaluation values or ranking scores for candidate objects so as to select preferred candidate objects.

The term “candidate object” refers to an item, entity, or target that can be recommended or matched to the user, including at least one of a product, a service, digital content, a communication counterpart, a collaborator, or a community.

The term “dialogue history information” refers to data representing a sequence of interactions between the user and the system, including at least prompt sentences, question sentences, response texts, proposal sentences, and time stamps.

The term “emotion analysis model” refers to a computational model configured to receive as input at least one of text data, audio data, image data, or interaction data, and to output an estimate of a user emotional state.

The term “user emotional state” refers to data representing an affective condition of the user, such as joy, sadness, anger, surprise, or combinations and intensities thereof, estimated by the emotion analysis model.

The term “user interface apparatus” refers to an apparatus, such as a terminal device, display unit, or graphical user interface subsystem, that presents information from the server to the user and acquires further input from the user.

The term “natural-language proposal sentence” refers to a sentence or set of sentences generated by the generative information processing model in natural language, configured to present selected candidate objects and associated explanations to the user.

The term “selection information” refers to data representing a user's explicit choice among candidate objects, such as selection of a particular item, confirmation of a recommendation, or initiation of an action relating to a candidate object.

The term “operation history information” refers to data representing chronological records of user operations performed via the user interface apparatus, including at least one of scrolling, clicking, tapping, hovering, and form submissions.

The term “learning data” refers to data used to train or update parameters of a machine-learning model, including at least user behavior information, user attribute information, and labels or targets derived from system outcomes.

The term “relationship-demand group” refers to a cluster or grouping of users or states, obtained by clustering user attribute information and user behavior information, that indicates a common pattern of potential relationship or connection needs.

The term “potential relationship target” refers to a candidate object representing a person, account, or entity that may form a cooperative or communicative relationship with the user, as inferred by the recommendation model.

The term “potential purchase target” refers to a candidate object representing a product, service, or transaction item that the user is likely to acquire, as inferred by the recommendation model.

In one embodiment, a server, a plurality of terminals, and a communication network cooperate to implement the claimed system. The server includes at least one processor, a main memory, a non-transitory storage device, and a network interface. The terminals include user interface hardware such as displays, touch panels, cameras, microphones, and local processors capable of executing application software. The communication network may include wired and wireless links and standardized communication protocols such as TCP/IP and HTTPS.

The server stores executable programs in the storage device. The executable programs define processing modules including at least a natural language processing module, a prompt-generation module, a generative AI model interface module, a recommendation module, an emotion analysis module, a model-update module, and a logging module. The server also stores data structures including at least a user attribute database, a user behavior database, a dialogue history database, a prompt and response log, and model parameter stores.

The server stores the user attribute information and the user behavior information in structured tables, for example in a relational database management system such as a general-purpose database server. Each user entry may include a user identifier, profile attributes, interest categories, skill categories, and preference ratings. Each behavior record may include a timestamp, a request identifier, a prompt sentence identifier, a generative output identifier, selection information, and operation history information. The server uses indexing structures, such as B-tree or hash indexes, to accelerate retrieval of behavior records by user identifier and time range, which reduces storage access time and improves I/O efficiency.

The server uses a natural language processing library, such as a general-purpose neural language processing toolkit, to implement the natural language processing module. The server loads trained language models into memory. These language models may include tokenizers, part-of-speech taggers, and named entity recognizers based on neural network architectures such as bidirectional LSTM networks or transformer encoders. The server applies these models to user request information and user response information to produce token sequences, syntactic tags, and a set of extracted entities and key phrases. The server stores the token sequences and entities in intermediate data structures, such as arrays and key-value maps, which are then consumed by the prompt-generation module and the recommendation module.

The server represents a low-resolution request as a record that includes the original text, the extracted keywords, the inferred intent label, and a resolution flag. The server sets the resolution flag to a first value when the natural language processing module determines that the request lacks sufficient constraint fields, such as a missing category dimension, a missing budget dimension, or a missing counterpart type dimension. The server uses rule-based logic combined with trained classifiers to perform this determination, which enables the system to avoid passing under-specified feature vectors to the recommendation model and thereby reduces unnecessary candidate scoring computations.

The server implements the generative AI model interface module as a component that formats a prompt sentence, sends it to a generative AI model, and parses the returned output. In one embodiment, the generative AI model is a large-scale neural language model trained using a transformer architecture having multiple self-attention layers, feed-forward sublayers, and layer normalization. The server stores a model identifier and configuration parameters, such as context window size, sampling temperature, and maximum output length, in a configuration table. The server passes a prompt sentence and control parameters to the generative AI model, which returns a natural-language output sequence.

The server constructs the prompt sentence by concatenating structured fields, including the original user request, the intention information, the keyword information, and a set of explicit instructions. The server may generate different prompt templates depending on the processing stage. For example, the server may construct a clarifying prompt as:
“The user says: ‘I want to buy something new.’

Extracted keywords: [buy, new].

Ask the user one or two clarifying questions to identify product category and budget.

Output only the user-facing questions.”

The server may construct a recommendation explanation prompt as:
“User profile: interested in casual fashion, budget around 100 dollars.

Current emotional state: joy.

Candidate products:
1) Product A: casual jacket, 95 dollars, eco-friendly.
2) Product B: sneakers, 90 dollars, street style.
3) Product C: hoodie, 80 dollars, bright colors.

Generate a friendly, concise recommendation message for the user.

Explain briefly why each product fits the user's interests, budget, and emotional state.”

The server thereby uses the prompt sentence as a machine-targeted control structure that conditions the generative AI model not only on the raw text but also on the internal state of the system, such as selected candidates, emotional labels, and feature vector components. This structured conditioning is not available to a human operator and results in a non-conventional interaction between the recommendation module and the generative AI model, which improves the technical behavior of the system.

The server implements the recommendation module using a machine learning framework, such as a general-purpose tensor computation library, and defines a neural network that takes feature information as input and outputs evaluation values for candidate objects. In one embodiment, the neural network includes an embedding layer for categorical features (such as interest categories, skill categories, and emotional labels), one or more fully connected layers with rectified linear unit activation functions, and an output layer that produces scores for each candidate object. The server trains this network using a supervised learning procedure with a loss function such as a cross-entropy loss or a pairwise ranking loss that reflects observed user selections and non-selections.

The server constructs the feature information as a feature vector composed of the following components: a numerical encoding of user attribute information, a numerical encoding of user behavior information, a numerical encoding of user response information, and a numerical encoding of user emotional state. The server may normalize continuous features, one-hot encode categorical features, and embed high-cardinality identifiers using learned embeddings. The server concatenates these encoded components into a single tensor, which the recommendation model processes to compute candidate scores. Because the feature vector explicitly contains dynamically updated emotional state and clarifying information produced by the generative interaction, the recommendation model can reduce prediction error compared to a model that relies only on static attributes, thus improving accuracy and reducing the number of iterations required to converge to relevant candidates.

The server implements the emotion analysis module using either a dedicated neural network or an external emotion analysis service. In one embodiment, the server uses a text-based classifier built on a transformer encoder fine-tuned on labeled emotion datasets. The classifier takes tokenized user text (requests, responses, and dialogue history) as input and outputs a probability distribution over emotion classes, such as joy, sadness, anger, and neutral. The server may also connect to a multimodal emotion recognition engine that processes image and audio streams provided by the terminals and outputs additional emotion attributes, such as facial expression scores and prosody-based affect estimates. The server aggregates these signals into a user emotional state vector that is stored in the user behavior database and provided as part of the feature vector to the recommendation module.

The server defines clustering logic within the recommendation module to form relationship-demand groups. For example, the server may apply a clustering algorithm such as k-means clustering to high-dimensional embeddings of user behavior information and user attribute information. The server first reduces dimensionality using techniques such as principal component analysis or autoencoder-based compression, and then applies clustering in the reduced space. Each cluster then represents a relationship-demand group. The server uses these groups as additional features in the recommendation model and as filters to limit the candidate search space when selecting potential relationship targets and potential purchase targets. By partitioning the user space in this way, the server reduces the number of candidate evaluations and improves computational efficiency.

The server implements the model-update module to periodically retrain or fine-tune the recommendation model and the emotion analysis model. The server reads logged user behavior information, including prompt sentences, model outputs, selection information, and operation history information. The server constructs training examples in which the feature vectors are paired with labels derived from actual user selections and downstream actions, such as purchases or accepted connections. The server uses a gradient-based optimization algorithm, such as stochastic gradient descent or Adam, to update model weights. The server computes gradients of the loss function with respect to the weights, and updates the weights according to the learning rate and regularization parameters. Because the server explicitly logs the association between prompt sentences, generated proposal sentences, and user behavior, the training process can capture how different prompt structures influence user actions, leading to more robust and efficient model behavior in subsequent deployments.

The terminal operates as a user interface apparatus. The terminal executes an application that presents chat-like interfaces and recommendation views. The terminal displays question sentences and proposal sentences generated by the server, and acquires user response information via input widgets. The terminal can access camera and microphone hardware to capture facial images and voice, which it optionally transmits to the server or an emotion recognition engine. The terminal reduces local processing by delegating heavy natural language and recommendation computation to the server, which allows lower-power devices to participate while the overall system performance improves through centralized optimization.

The user interacts with the system through the terminal. The user inputs free-form natural-language requests, reads clarifying questions, and provides responses. The user reviews recommended candidate objects and selects or rejects them. The user's interactions form part of the user behavior information that the server logs and uses as learning data.

In one specific example, the user inputs the vague request “I want to buy something new.” The server uses the natural language processing module to identify that the request lacks category and budget. The server constructs the clarifying prompt sentence:
“The user says: ‘I want to buy something new.’

Extracted keywords: [buy, new].

Ask the user one or two clarifying questions to identify product category and budget.

Output only the user-facing questions.”

The generative AI model returns questions such as “Which category are you most interested in? Fashion, gadgets, books, or something else?” and “What is your approximate budget?” The terminal displays these questions. The user responds “Fashion, about 100 dollars.” The server encodes this information into the feature vector, queries the recommendation model, selects candidate products, and then constructs a second prompt sentence:
“User profile: interested in casual fashion, budget around 100 dollars.

Current emotional state: joy.

Candidate products:
1) Product A: casual jacket, 95 dollars, eco-friendly.
2) Product B: sneakers, 90 dollars, street style.
3) Product C: hoodie, 80 dollars, bright colors.

Generate a friendly, concise recommendation message for the user.

Explain briefly why each product fits the user's interests, budget, and emotional state.”

The generative AI model returns a natural-language proposal sentence explaining the candidates, which the terminal shows to the user. Because the system uses the prompt sentence to drive both clarification and explanation stages, and because the recommendation model uses emotional state and clarified fields as features, the server reduces the amount of redundant candidate evaluation and produces higher-precision results compared to a system that only performs static matching.

In another example, the user has a history of participating in several data analysis-related events and watching data analysis videos. The server clusters the user into a relationship-demand group that indicates “data-focused collaborators.” The user inputs “I want to find a new project partner.” The server detects the request as low-resolution with respect to industry and role. The server constructs a clarifying prompt sentence that asks for the desired industry and project type. After receiving answers, the server computes a feature vector that includes the relationship-demand group, the clarified attributes, and a current emotional state (for example, joy after a recent success). The recommendation model selects potential collaborators who share similar event participation histories. The server constructs a prompt sentence such as:
“User has skills in data analysis and project management, attended data analysis events, and feels joy after a recent success.

Candidate collaborators:
1) Collaborator A: data engineer, attended Data Event X.
2) Collaborator B: analyst, attended Data Event Y.
3) Collaborator C: project manager, attended Data Event X and Y.

Suggest three suitable collaborators and explain briefly why each is a good match for the user.”

The generative AI model returns explanation text, and the terminal displays collaborator profiles and reasons. This architecture allows the server to reduce the search space by using the relationship-demand groups as constraints before consulting the generative AI model, leading to improved response time and reduced computational load on the recommendation model.

The use of the generative AI model in this system is not limited to automating human dialogue. The server uses the generative AI model as a programmable component that is controlled by the prompt sentences, which embed internal machine state. The prompt sentences are themselves outputs of deterministic logic and trained models in the server. This structured interplay allows the system to generate machine-consistent clarifications and explanations that integrate seamlessly with numerical models, which is not the case for systems that only use generative models as cosmetic text generators. The resulting architecture improves the internal operation of the computer system by reducing wasted computation on irrelevant candidates, improving caching and reuse of intermediate representations, and increasing the predictive accuracy of downstream models.

In another embodiment, the server may deploy different neural network architectures as the recommendation model, such as gradient-boosted tree models or hybrid models combining factorization machines with deep neural networks. The server may also vary the emotion analysis model, for example using convolutional neural networks for image-based emotion recognition or recurrent neural networks for sequence-based sentiment analysis. The server may adjust the feature composition, such as including time-of-day features, device type features, or interaction frequency features, to further refine recommendations.

The server may also execute a variant in which a local generative model is partially hosted on the terminal for offline or low-latency scenarios. In such a case, the server transmits model parameters or distilled submodels to the terminal, and the terminal executes prompt-conditioned generation locally. The server still manages global model training and distributes updated parameters periodically. This configuration can further reduce network latency and bandwidth consumption while maintaining alignment between generative behavior and central recommendation logic.

Because the server maintains explicit data structures that bind prompt sentences, generated outputs, feature vectors, and behavior logs, the system provides traceability and allows model developers to analyze how specific prompts affect outcomes. This traceability is not obtainable through manual analysis of unstructured chat logs. By structuring the data in this way, the server can implement optimization routines that adjust prompt templates, model hyperparameters, and feature encodings in response to observed system performance, thus providing a concrete improvement in computer system operation beyond generic automation of human tasks.

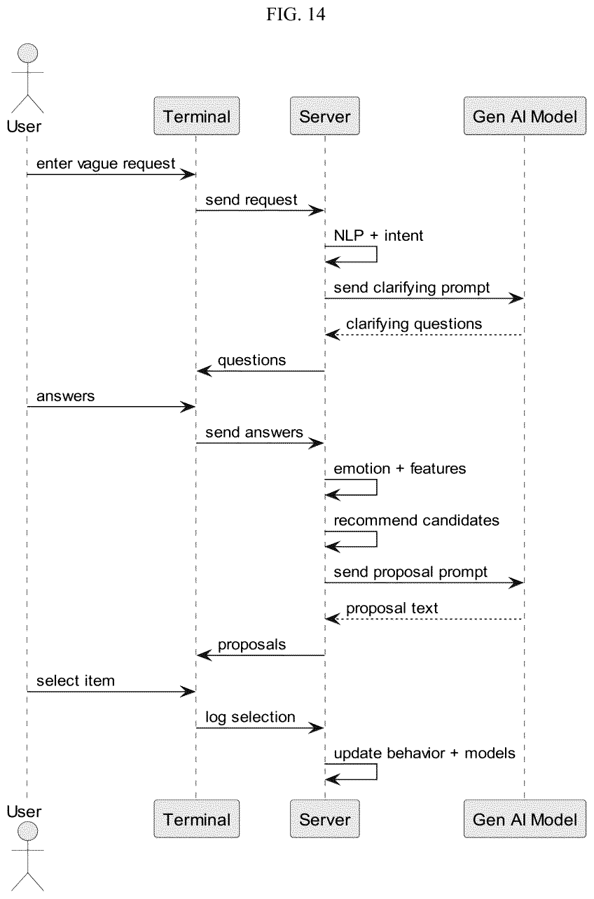

The following describes the processing flow using FIG. 14.

### Step 1:

User launches an application and submits a low-resolution request.

User operates the terminal to start an application and, after authentication, enters a free-form natural-language request such as “I want to buy something new” or “I want to find a new project partner.”

Input: raw natural-language text from the user, user identifier, and optional permission flags for camera and microphone.

Output: a request payload comprising the text, the user identifier, and device metadata.

Terminal packages this payload into a structured message (for example, JSON over HTTPS) and transmits it to the server. Terminal may additionally capture facial images and voice signals through a camera and microphone and attach encoded media data if the user has granted permission.

### Step 2:

Server receives and logs the request.

Server accepts the incoming request payload via a network interface and parses the protocol headers and body.

Input: request payload containing user text, user identifier, timestamp, device type, and optional media data.

Output: stored request record in a request table and a temporary analysis record identifier.

Server writes the raw text and metadata into a user behavior database and assigns a unique request identifier. Server records a link between this request identifier and the user identifier to support later retrieval and training.

### Step 3:

Server performs natural language processing on the request text.

Server invokes a natural language processing module that tokenizes the request text, assigns part-of-speech tags, and performs named entity recognition and intent classification.

Input: request text associated with the request identifier.

Output: token sequence, intent label, list of extracted entities and keywords, and a low-resolution flag.

Server converts the text into tokens using a tokenizer, applies a syntactic tagger and an entity recognizer implemented as neural networks or statistical models, and passes the resulting features to an intent classifier. Server determines whether required slots such as category, budget, or counterpart type are missing and sets the low-resolution flag accordingly. Server stores the analysis results in an analysis table linked to the request identifier.

### Step 4:

Server determines whether the request is low-resolution and selects a processing path.

Server evaluates the low-resolution flag and, if necessary, checks rule conditions and classifier outputs to decide if clarification is required.

Input: intent label, extracted keywords, and low-resolution flag from the analysis table.

Output: a decision value indicating “clarification required” or “sufficiently specified.”

Server performs conditional checks on missing slots and confidence scores. If clarification is required, the server prepares to generate a clarifying prompt sentence for a generative AI model. If not, the server skips to direct recommendation processing.

### Step 5:

Server generates a clarifying prompt sentence for the generative AI model.

Server constructs a prompt sentence by combining the original request, the extracted intention information, the keyword information, and a set of template instructions tailored for clarification.

Input: original request text, extracted intention information, keyword information, and user attribute information retrieved from the user attribute database.

Output: a first prompt sentence designed to cause the generative AI model to produce clarifying questions.

Server fetches basic user attributes (for example, typical categories, budget range) and inserts this context into an instruction string. Server concatenates fixed template phrases and dynamic fields to form a structured, machine-targeted prompt, for example:
“The user says: ‘I want to buy something new.’

Extracted keywords: [buy, new].

Ask the user one or two clarifying questions to identify product category and budget.

Output only the user-facing questions.”

Server stores this prompt sentence in a prompt log table linked to the request identifier.

### Step 6:

Server calls the generative AI model to obtain clarifying questions.

Server transmits the constructed first prompt sentence to a generative AI model interface, specifying model parameters such as model name, temperature, and maximum tokens.

Input: first prompt sentence and model configuration parameters.

Output: generated question sentences intended for user presentation.

Server sends the prompt to the generative AI model, which processes the text with a transformer or similar architecture and returns a text output. Server receives the output as a token sequence, decodes it to text, and parses it into one or more question sentences. Server logs the returned text along with the corresponding prompt identifier.

### Step 7:

Terminal receives and displays the clarifying questions.

Terminal obtains the generated question sentences from the server through a response message.

Input: response payload containing the question sentences and a request identifier.

Output: rendered question interface elements on the terminal display.

Terminal converts the question sentences into conversational UI components, such as chat bubbles or labeled form fields, and displays them to the user. Terminal prepares input controls (for example, text boxes, option buttons) associated with the questions so the user can respond.

### Step 8:

User provides clarification responses.

User reads the displayed questions and provides additional information, such as “Fashion” and “Around 100 dollars,” or “Data analysis partner in the finance industry.”

Input: question sentences presented on the terminal, and user interaction with input widgets.

Output: user response information including textual answers, selected options, and contextual cues.

Terminal captures the responses and includes associated metadata such as which question each response answers and the request identifier.

### Step 9:

Terminal sends clarification responses to the server.

Terminal aggregates the user responses into a structured response payload.

Input: raw input values from user interface widgets and links to question identifiers.

Output: a response message containing user response information and the original request identifier.

Terminal transmits this response message to the server using a secure communication protocol and may include client-side timestamps or device status indicators.

### Step 10:

Server integrates user responses with existing request analysis.

Server receives the response message and updates the analysis records for the relevant request.

Input: user response information, original intent label, extracted keywords, and low-resolution flag.

Output: an updated request representation including clarified slot values and an updated resolution flag.

Server parses the responses and maps them to structured fields, such as category, budget, style, industry, or role. Server updates the low-resolution flag to indicate that the request is now clarified. Server stores the structured response fields in the request analysis table and links them to the user attribute information and user behavior information.

### Step 11:

Server performs emotion analysis based on text and dialogue history.

Server executes the emotion analysis module on recent user utterances, including the original request and the clarification responses, and optionally on previous dialogue history.

Input: tokenized user text from the request and responses, and dialogue history information associated with the user.

Output: a user emotional state represented as a set of emotion scores or labels.

Server feeds tokenized text into an emotion classifier (for example, a transformer-based classifier) that outputs probabilities over emotion categories. Server may aggregate multiple turns by averaging or applying a temporal model to obtain a current emotional state vector. Server stores this emotional state as part of the user behavior information.

### Step 12:

Server constructs feature information for the recommendation model.

Server composes a feature vector that integrates user attribute information, user behavior information, user response information, and user emotional state.

Input: user profile attributes, historical behavior logs, clarified request slots, and emotional state vector.

Output: a numerical feature vector or tensor suitable for processing by the recommendation model.

Server retrieves relevant historical data from storage (for example, past purchases, event participation, viewing history) and encodes categorical fields via one-hot encoding or embeddings. Server normalizes continuous features such as budget and interaction frequency. Server includes the emotional state as an additional feature dimension. Server concatenates all encoded components into a single feature vector and caches it for further computation.

### Step 13:

Server computes candidate scores using the recommendation model.

Server applies the recommendation model to the feature vector and candidate representations to compute evaluation values for each candidate object.

Input: feature vector for the current user/request and representations of candidate objects (for example, item embeddings or attribute vectors).

Output: evaluation values or ranking scores for candidate objects.

Server may use a neural network or other machine learning model to map the feature vector and candidate vectors to a scalar score. Server iterates over candidate objects or employs approximate nearest-neighbor search in shared embedding space to efficiently compute rankings. Server stores the top-ranked candidates and associated scores for subsequent processing.

### Step 14:

Server may apply clustering to extract relationship-demand groups.

Server optionally applies a clustering algorithm to user attribute information and user behavior information to assign the user to a relationship-demand group.

Input: user feature representations and cluster model parameters (for example, centroids).

Output: a group identifier or cluster label representing a relationship-demand group.

Server computes distances between the user feature vector and pre-computed cluster centroids, assigns the user to the nearest cluster, and appends the cluster label as a feature for further filtering. Server uses this cluster label to narrow candidate sets to those associated with the same or compatible groups, which reduces the search space.

### Step 15:

Server selects candidate objects based on scores and groups.

Server selects final candidate objects by combining evaluation values with cluster constraints, thresholds, and diversity criteria.

Input: evaluation values for candidate objects, optional relationship-demand group labels, and ranking thresholds.

Output: a selected candidate object set, such as products, content, or collaborators.

Server filters out candidates whose scores are below a threshold or that do not satisfy group compatibility constraints. Server may apply re-ranking to maintain diversity across categories or types and produces a list of selected candidate objects with associated metadata.

### Step 16:

Server generates a second prompt sentence for user-facing proposals.

Server constructs a second prompt sentence that instructs the generative AI model to generate natural-language proposals and explanations for the selected candidates.

Input: selected candidate objects, user attribute information, clarified request fields, and user emotional state.

Output: a second prompt sentence describing context and desired style of the generated message.

Server retrieves candidate metadata (names, descriptions, prices, skills, or roles) and inserts them into a template along with information such as “User profile: interested in casual fashion, budget around 100 dollars. Current emotional state: joy.” Server then appends an instruction such as “Generate a friendly, concise recommendation message for the user. Explain briefly why each product fits the user's interests, budget, and emotional state.” Server logs this second prompt sentence in association with the request.

### Step 17:

Server calls the generative AI model to generate proposal text.

Server transmits the second prompt sentence to the generative AI model with appropriate generation parameters.

Input: second prompt sentence and model generation parameters (for example, temperature, maximum length).

Output: a natural-language proposal sentence or multiple sentences describing and recommending candidate objects.

Server receives the generated text sequence from the generative AI model, decodes it, and performs basic validation (for example, length checks, forbidden term filtering). Server retains references to the candidate objects mentioned in the text to link user selections back to specific items.

### Step 18:

Server sends generated proposals and candidate data to the terminal.

Server formats a response payload that includes the natural-language proposal sentences, structured information about each candidate object, and identifiers needed for logging user actions.

Input: generated proposal text and selected candidate object metadata.

Output: a response message containing display-ready content and hidden identifiers.

Server serializes the data into a transferable format and sends it to the terminal through the network interface. Server records the time of transmission and updates the dialogue history information.

### Step 19:

Terminal renders recommendations and interaction elements.

Terminal receives the response payload and constructs display components such as item cards, collaborator profiles, or content tiles.

Input: response message containing proposal sentences and candidate object metadata.

Output: visual presentation and interactive controls on the terminal screen.

Terminal displays the proposal sentences as narrative explanations and attaches buttons such as “View details,” “Add to cart,” “Connect,” or “Join community” to each candidate object. Terminal may also adjust UI style (for example, color or tone) in accordance with emotional hints conveyed in the proposal text.

### Step 20:

User reviews proposals and performs selections or actions.

User reads the narrative proposals and examines candidate objects, then selects one or more actions, such as purchasing an item, viewing detailed information, or initiating contact with a collaborator.

Input: displayed recommendations and controls on the terminal.

Output: user selection information and operation history information (for example, which items were clicked, viewed, or ignored).

Terminal captures these actions along with timestamps and context and prepares them for transmission to the server.

### Step 21:

Terminal transmits selection and operation history to the server.

Terminal composes a behavior log payload representing the user's interactions with the proposals.

Input: user clicks, selections, scrolls, and other UI interactions with associated candidate identifiers.

Output: a behavior log message sent to the server.

Terminal includes in the payload the request identifier, prompt sentence identifiers, candidate object identifiers, and user choices, then sends this data to the server.

### Step 22:

Server records behavior logs and updates user behavior information.

Server receives the behavior log message and updates the user behavior database.

Input: behavior log payload from the terminal.

Output: updated user behavior records including selection information and operation history information.

Server stores each interaction as a record that links the user identifier, request identifier, prompt identifiers, candidate identifiers, and actions taken. Server may compute summary statistics such as click-through rates or dwell times and append them to aggregate behavior tables.

### Step 23:

Server prepares training data for model updates.

Server periodically extracts logged behavior and prompt data to construct training examples for the recommendation model and emotion analysis model.

Input: historical user behavior information, user attribute information, prompt sentences, and generated outputs.

Output: training datasets comprising feature vectors and target labels or scores.

Server reconstructs feature vectors used at recommendation time and pairs them with observed outcomes, such as whether a candidate was selected or purchased. Server defines labels or rewards based on these outcomes and organizes them into batches suitable for training. Server similarly aggregates text and emotion labels for updating the emotion analysis model.

### Step 24:

Server updates model parameters using learning algorithms.

Server runs a training routine that updates parameters of the recommendation model and emotion analysis model with the newly collected learning data.

Input: training datasets of feature vectors and labels, current model parameters, and learning hyperparameters.

Output: updated model parameters stored in the model parameter store.

Server computes forward passes through the models for each training batch, calculates loss values using appropriate loss functions (for example, cross-entropy, mean squared error, or ranking loss), computes gradients with respect to model weights, and updates the weights using an optimizer such as stochastic gradient descent or Adam. Server evaluates performance on validation data and, when performance improves, deploys the new parameters to the online inference pipeline. Server thereby improves future recommendation accuracy and emotion detection quality.

### Step 25:

Server optionally adjusts prompt templates and configuration.

Server analyzes the relationships between prompt sentences, generative outputs, and user behavior to refine prompt templates and control parameters.

Input: logs of prompt sentences, generated texts, and subsequent user actions.

Output: updated prompt templates, instruction phrases, and generation parameter settings.

Server detects patterns where certain prompt structures lead to higher engagement or more precise selections. Server modifies template text, ordering of information, or instructions (for example, specifying “ask at most two questions” or “use concise explanations”) and updates the stored templates. Server may also adjust generative model parameters such as sampling temperature to balance diversity and determinism. This feedback loop enables the system to refine not only numerical models but also the structure of prompt sentences that control the generative AI model.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

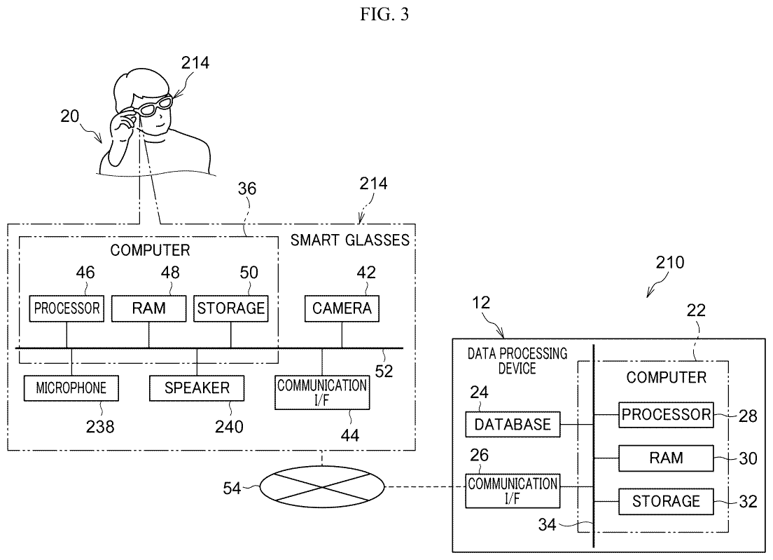

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

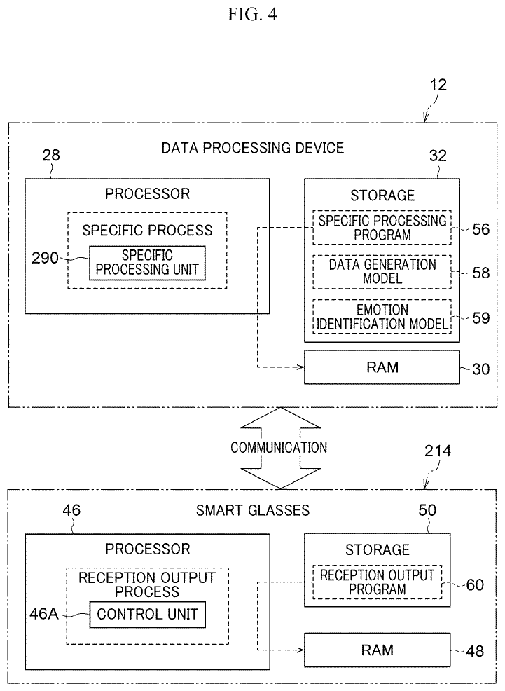

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

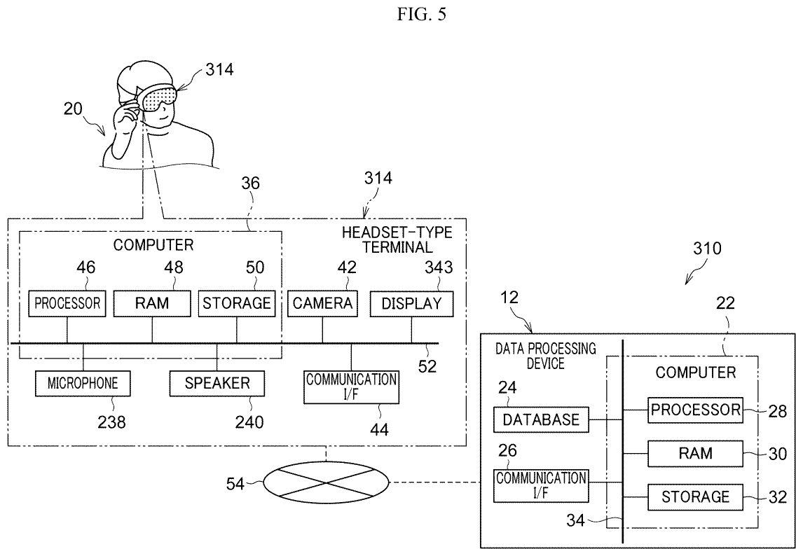

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

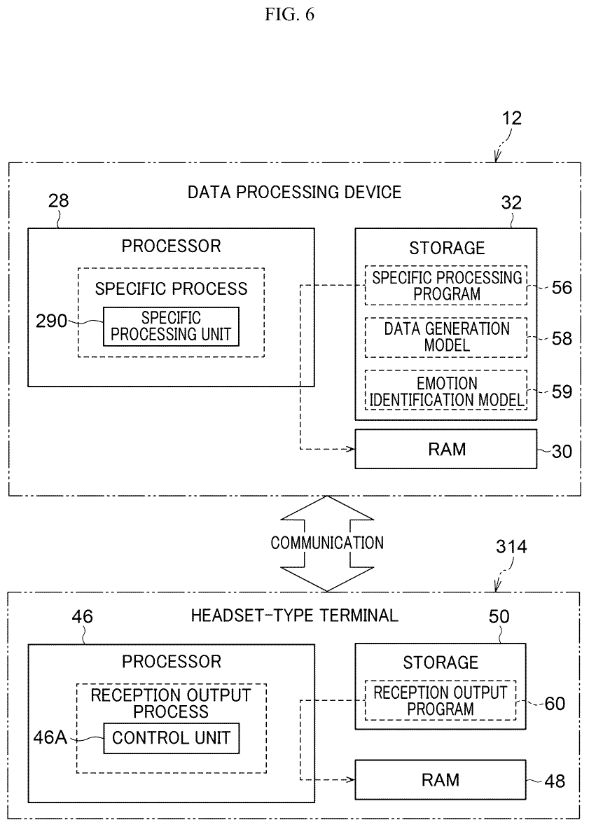

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

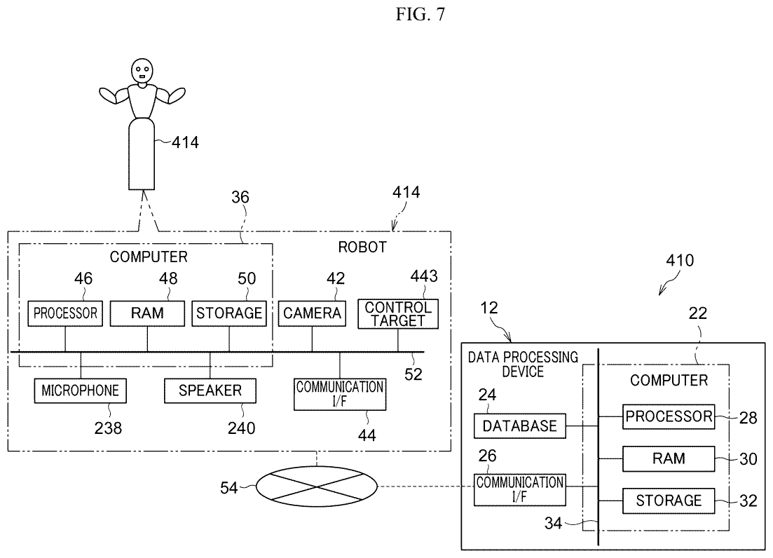

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

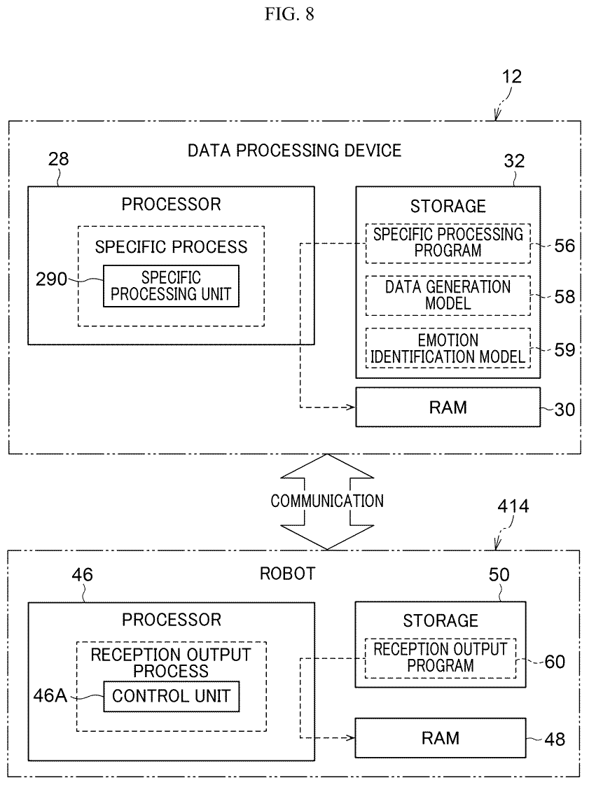

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

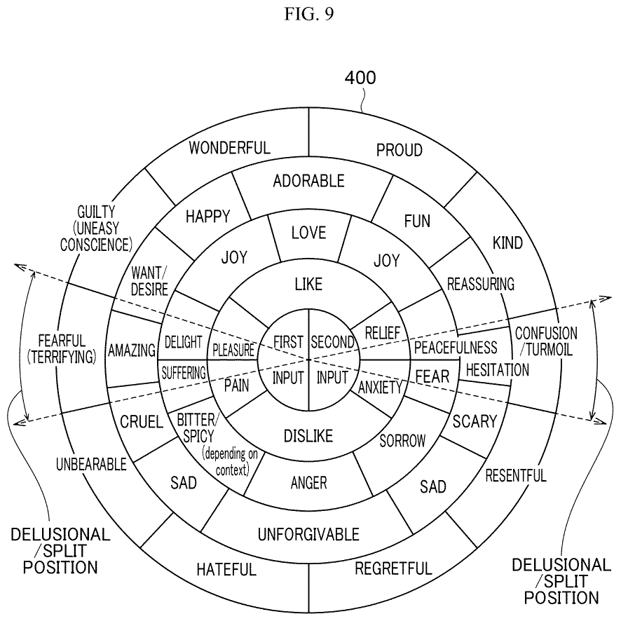

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

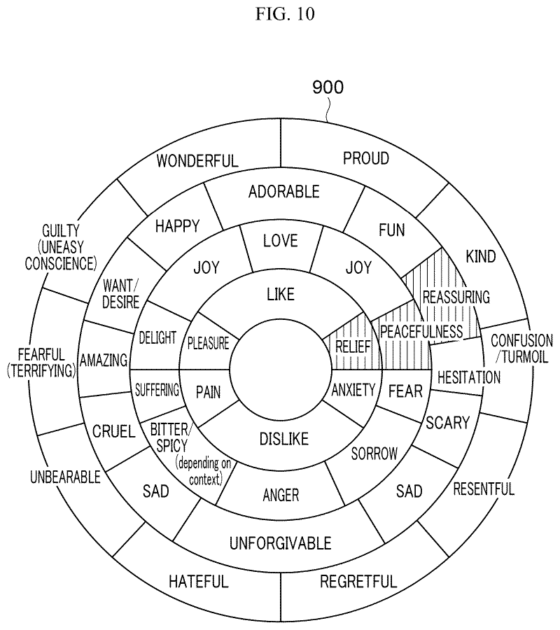

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from a communication terminal, user interest information and user skill information, verify the user interest information and the user skill information, and store the verified user interest information and the verified user skill information in an information storage device, preprocess text information based on the user interest information and the user skill information stored in the information storage device for a plurality of users, generate vector representations of the text information in a feature space, calculate similarities between the vector representations to extract pairs of users having similarity indices, and select connection candidate users based on the similarity indices,
generate notification information including connection proposal information for the selected connection candidate users, and transmit the notification information to the selected connection candidate users by using an electronic communication unit or an in-platform notification function,
generate an interaction screen or a bulletin screen for information exchange between a plurality of users based on the notification information, record message information transmitted and received through the interaction screen or the bulletin screen in the information storage device, and relay the message information to a counterpart user,
generate a prompt sentence that instructs analysis of the user interest information and the user skill information, clarification of user requirements, and analysis of a user emotional state to generate proposal information,
and transmit the prompt sentence to an external generative information processing model, receive response information from the external generative information processing model, and use the response information as control information to update at least a part of the user interest information, the user skill information, the similarity indices, or selection conditions for the connection candidate users.

### (Supplementary 2)

The system according to supplementary 1,
wherein the processor is configured to dynamically adjust a preprocessing method for the text information, generation conditions for the vector representations in the feature space, or threshold values for the similarity indices, based on the response information from the generative information processing model, to improve selection accuracy of the connection candidate users.

### (Supplementary 3)

The system according to supplementary 1,
wherein the processor is configured to analyze user behavior history information and profile information recorded in the information storage device, extract patterns indicating potential connection demand, and automatically generate or modify content of the prompt sentence or the connection proposal information based on the potential connection demand.

### Application Example 1

### (Supplementary 1)

A system comprising a processor,
wherein the processor is configured to
acquire, via a communication device, user interest information and user capability information transmitted from a user terminal, and store the user interest information and the user capability information in a storage device,
calculate similarity between users based on the user interest information and the user capability information stored in the storage device, and extract collaborator candidate users based on the similarity,
transmit information on the collaborator candidate users to the user terminal, cause a display device of the user terminal to present a list of the collaborator candidate users, generate a communication session based on a collaborator candidate user selected by the user terminal, and construct a real-time information exchange environment via the communication session,
generate context information including ambiguous request information acquired from the user terminal and the user interest information and the user capability information, input the context information to a generation device, and generate a prompt sentence that encourages clarification of the ambiguous request information by using a generative model,
transmit the generated prompt sentence to the user terminal and prompt a user to clarify contents of the request, and
analyze user behavior information, the user interest information, and the user capability information accumulated in the storage device to extract latent patterns relating to relationship demands, and present new collaborator candidate users or information resources based on the latent patterns.

### (Supplementary 2)

The system according to supplementary 1,
wherein the processor is configured to
use a generative artificial intelligence model as the generative model to generate the prompt sentence, and provide, as the context information input to the generative artificial intelligence model, at least the user interest information, the user capability information, and dialogue history information.

### (Supplementary 3)

The system according to supplementary 1,
wherein the processor is configured to
store, in the storage device, dialogue content in the communication session and response content of the user to the presented prompt sentence, and reuse the stored dialogue content and the response content in at least one of the calculation of the similarity or the extraction of the latent patterns.

### Example 2

### (Supplementary 1)

A system comprising a processor and a memory,
wherein the processor is configured to
acquire, via a terminal, abstract request information input by a user, and store the abstract request information as request data in the memory,
generate a prompt sentence based on the request data, the prompt sentence instructing a generative AI model to perform at least analysis of interest information and capability information of the user, clarification of contents of a request of the user, analysis of an emotional state of the user, and generation of proposal information,
input the prompt sentence to the generative AI model disposed externally or internally with respect to the system, and cause the generative AI model to analyze the abstract request information to identify missing information and to generate specific question sentences for stepwise clarification of the contents of the request,
transmit the specific question sentences generated by the generative AI model to the terminal and cause the terminal to present the specific question sentences to the user,
acquire, via the terminal, answer information input by the user in response to the specific question sentences, store the answer information in association with the request data in the memory, and update a dialogue state for converting the abstract request information into concrete target information,
determine, on the basis of the request data and the answer information, a degree of concretization of the contents of the request, and when the contents of the request are determined to be insufficient, update the prompt sentence to be input to the generative AI model and cause the generative AI model to generate additional specific question sentences, and when the contents of the request are determined to be sufficiently concrete, automatically extract collaborator information or related information source information on the basis of the request data and the answer information, and
transmit the concrete target information and the collaborator information or the related information source information to the terminal and cause the terminal to present the concrete target information and the collaborator information or the related information source information to the user.

### (Supplementary 2)

The system according to supplementary 1,
wherein the processor is configured to cause the generative AI model to convert at least the abstract request information and the answer information into token sequences by using a natural language processing algorithm, to generate internal representation vectors, and to sequentially generate the specific question sentences or the proposal information on the basis of the prompt sentence.

### (Supplementary 3)

The system according to supplementary 1,
wherein the processor is configured, in extracting the collaborator information or the related information source information, to generate the concrete target information from the request data and the answer information, calculate similarity between the concrete target information and a plurality of profile information items stored in the memory and representing collaborators or information sources, and select candidate information to be presented to the user on the basis of the similarity.

### Application Example 2

### (Supplementary 1)

A system comprising a processor and a storage device,
wherein the processor is configured to
analyze request information acquired from a user by an information processing apparatus using natural language processing to determine whether the request information is a low-resolution request, and to extract intention information and keyword information from the request information,
generate a first prompt sentence for input to a generative information processing model on the basis of the intention information, the keyword information, user attribute information, and user behavior information stored in the storage device, transmit the first prompt sentence to the generative information processing model, and obtain, from the generative information processing model, at least one of a question sentence for clarifying the low-resolution request and a candidate proposal sentence,
acquire user response information to the question sentence, integrate the user response information with the user behavior information and the user attribute information, generate feature information for input to a recommendation model, and cause the recommendation model to calculate an evaluation value for each candidate object and to select a candidate object on the basis of the evaluation value,
input the user response information and dialogue history information with the user into an emotion analysis model to estimate a user emotional state, and include the estimated user emotional state in the feature information so as to reflect the user emotional state in selection of the candidate object,
generate a second prompt sentence for presentation to the user for input to the generative information processing model on the basis of the selected candidate object, the user attribute information, the user behavior information, and the user emotional state, obtain a natural-language proposal sentence from the generative information processing model, and output the natural-language proposal sentence to a user interface apparatus, and
record selection information and operation history information from the user in the storage device as the user behavior information, and update at least one of the recommendation model and the emotion analysis model by using the user behavior information as learning data.

### (Supplementary 2)

The system according to supplementary 1,
wherein the processor is configured to cause the generative information processing model, based on the first and second prompt sentences, to generate: a description sentence that analyzes user interest information and user skill information, an additional question sentence that clarifies the low-resolution request, and at least one of a recommendation reason sentence and a follow-up question sentence corresponding to the user emotional state.

### (Supplementary 3)

The system according to supplementary 1,
wherein the processor is configured to cause the recommendation model to perform clustering on the user behavior information and the user attribute information using a machine learning algorithm to extract relationship-demand groups, and to automatically select, as the candidate object, at least one of a potential relationship target and a potential purchase target on the basis of the relationship-demand groups and the user emotional state.

What is claimed is:

1. A system comprising:
circuitry configured to:
receive, via a communication interface coupled to a packet-switched network, attribute data associated with a user from a terminal device;
generate a first instruction data set that directs a generative model to analyze the attribute data to extract structured feature information representing characteristics of the user;
generate a second instruction data set that directs the generative model to produce clarification queries based on the attribute data, the clarification queries configured to resolve ambiguity in request data received from the terminal device;
transmit the clarification queries to the terminal device via the communication interface and receive response data from the terminal device;
evaluate a completeness measure of the request data based on the response data against a set of predefined attribute categories; and
generate a third instruction data set that directs the generative model to estimate an affective state of the user from at least the response data and to produce recommendation data conditioned on the estimated affective state.

2. The system according to claim 1, wherein the circuitry is configured to:
convert the attribute data for a plurality of users into vector representations in a feature space using a term-weighting transformation, and
compute similarity indices between the vector representations to identify candidate entities satisfying a similarity threshold.

3. The system according to claim 2, wherein the circuitry is configured to:
dynamically adjust at least one of a preprocessing method applied to the attribute data, generation conditions for the vector representations, or the similarity threshold, based on output data received from the generative model in response to the first instruction data set.

4. The system according to claim 1, wherein the circuitry is configured to:
maintain a dialogue state data structure that associates the request data with the clarification queries and the response data, and
iteratively update the dialogue state data structure by generating additional clarification queries until the completeness measure satisfies a predetermined criterion.

5. The system according to claim 4, wherein the completeness measure is computed as a completeness vector over the predefined attribute categories, and the circuitry determines whether each attribute category is resolved by performing text classification and entity extraction on the response data.

6. The system according to claim 1, wherein the circuitry is configured to:
analyze behavior history data and profile data stored in a storage device to extract a latent pattern indicating an inferred association demand, and
modify at least one of the first instruction data set, the second instruction data set, or the recommendation data based on the latent pattern.

7. The system according to claim 6, wherein the behavior history data comprises at least one of event participation records, content access records, communication records, or interaction frequency data associated with the user.

8. The system according to claim 1, wherein the circuitry is configured to:
generate notification data comprising the recommendation data, and
transmit the notification data to the terminal device via at least one of an electronic message transmission unit or an application-layer notification channel.

9. The system according to claim 1, wherein the circuitry is configured to:
generate an interaction interface enabling real-time data exchange between a plurality of terminal devices, and
record message data transmitted through the interaction interface in a storage device.

10. The system according to claim 1, wherein the third instruction data set directs the generative model to analyze at least one of text data, audio data, or behavioral signal data associated with the user to estimate the affective state.

11. The system according to claim 10, wherein the circuitry is configured to:
apply an emotion identification model to map the estimated affective state to coordinates within a multi-dimensional emotion representation space.

12. The system according to claim 1, wherein the generative model comprises a transformer-based language model, and the circuitry is configured to:
tokenize each of the first, second, and third instruction data sets into token sequences, and
transmit the token sequences to the transformer-based language model via the communication interface.

13. The system according to claim 12, wherein the circuitry is configured to:
apply a deterministic decoding strategy when generating the clarification queries to reduce output variance.

14. The system according to claim 1, wherein the terminal device comprises at least one of a mobile computing device, a wearable display device, a headset-type terminal, or a robotic apparatus, each coupled to the packet-switched network via the communication interface.

15. The system according to claim 14, wherein the terminal device comprises the wearable display device including a microphone and a speaker, and the circuitry is configured to:
receive audio data representing user speech from the wearable display device, and
transmit audio output data to the speaker of the wearable display device based on the recommendation data.

16. The system according to claim 1, wherein the circuitry is configured to:
receive reinforcement signal data indicating user feedback on the recommendation data, and
adjust internal selection heuristics for subsequent generation of at least one of the first, second, or third instruction data sets based on the reinforcement signal data.

17. The system according to claim 1, wherein the circuitry is configured to:
convert the request data and the response data into concrete target information when the completeness measure satisfies the predetermined criterion, and
calculate similarity between the concrete target information and a plurality of stored profile data items to select candidate information to be presented to the user.

18. A system comprising:
a communication interface coupled to a packet-switched network and configured to communicate with a terminal device;
a storage device storing attribute data, request data, and response data; and
circuitry configured to:
receive, via the communication interface, attribute data associated with a user from the terminal device;
generate a first instruction data set that directs a generative model to analyze the attribute data to extract structured feature information representing characteristics of the user;
generate a second instruction data set that directs the generative model to produce clarification queries based on the attribute data, transmit the clarification queries to the terminal device via the communication interface, and receive response data from the terminal device;
evaluate a completeness measure of the request data based on the response data against a set of predefined attribute categories;
generate a third instruction data set that directs the generative model to estimate an affective state of the user from at least the response data and to produce recommendation data conditioned on the estimated affective state; and
transmit the recommendation data to the terminal device via the communication interface and the packet-switched network.

19. The system according to claim 18, wherein the storage device comprises a relational database having a user profile table, a dialogue state table, and a message table, and the circuitry accesses the relational database via parameterized queries.

20. A method performed by circuitry of a system comprising a communication interface coupled to a packet-switched network and a storage device, the method comprising:
receiving, via the communication interface, attribute data associated with a user from a terminal device;
generating a first instruction data set that directs a generative model to analyze the attribute data to extract structured feature information representing characteristics of the user;
generating a second instruction data set that directs the generative model to produce clarification queries based on the attribute data, the clarification queries configured to resolve ambiguity in request data received from the terminal device;
transmitting the clarification queries to the terminal device via the communication interface and receiving response data from the terminal device;
evaluating a completeness measure of the request data based on the response data against a set of predefined attribute categories; and
generating a third instruction data set that directs the generative model to estimate an affective state of the user from at least the response data and to produce recommendation data conditioned on the estimated affective state.
